(19) United States
(12) Patent Application Publication
(10) Pub. No.: US 2026/0202290 A1
(43) Pub. Date: Jul. 16, 2026

(54) SYSTEMS AND METHODS FOR EMBEDDING AND CUTTING TISSUE SAMPLE

(71) Applicant: Elephas Biosciences Corporation, Madison, WI (US)

(72) Inventors: Noah Van Der Weide, Madison, WI (US); Todd Bakken, Madison, WI (US); Christian Baltes, Madison, WI (US); Kevin Fantl, Madison, WI (US); Chao Liu, Madison, WI (US); Jacob Nesemeier, Madison, WI (US)

(21) Appl. No.: 19/449,911

(22) Filed: Jan. 15, 2026

Related U.S. Application Data
(60) Provisional application No. 63/745,517, filed on Jan. 15, 2025.

(51) Int. Cl. G01N 1/36; G01N 1/28; G01N 1/42

(52) U.S. Cl. CPC G01N 1/36; G01N 1/42; G01N 2001/2873; G01N 2001/366

(57) ABSTRACT

An embedding system and method for creating a sample assembly with a sample (e.g., a live tissue biopsy) in an embedding agent at a desired orientation. A cutting assembly and method for creating and collecting consistent and viable oblique slices of the sample.

### CROSS REFERENCE TO RELATED APPLICATIONS

This application claims priority to U.S. Provisional Patent Application No. 63/745517, filed on Jan. 15, 2025, the entire contents of which are incorporated herein by reference.

### FIELD

The present invention relates to devices, systems, and methods for cutting tissues. In some embodiments, the devices, systems, and methods of the invention relate to cutting tissues into slices that find use in tissue culture and drug testing applications.

### BACKGROUND

Conventional cutting devices section tissue embedded in a gel matrix, for example. However, the conventional systems are designed for general laboratory use and not specialized for the sectioning of biopsied tissue.

Conventional vibratome cutting systems, for example, only use one blade so the subsequent sections created are limited to the cross-section of the specimen along the travel path of the blade. Conventionally, vibratome cutting is performed within an aqueous buffer solution such that sections float to the top of a bath and are retrieved by an end user.

Conventional embedding procedures for tissue in gel exist, however, none streamline the process to, for example, facilitate the removal of media without direct user intervention or aligning a biopsy for the purpose of embedding.

Conventional histology procedures fix tissue in a fixative solution such as formalin, embed the fixed tissue in paraffin wax and then use a microtome to section the embedded tissue into thin sections which are transferred to slides. However, this conventional process kills the tissue as the fixative solution crosslinks proteins, terminating any ongoing biochemical reactions within cells.

Various diagnostic applications require tissue to be cut into thin sections. Conventional methods are limited by the speed of cutting and require one or more manual steps. As such, an unmet need exists to cut tissue into sections at high speed and precision, in an automated manner without causing significant mechanical damage to the tissue. It is also desirable to maintain maximum tissue viability for various downstream applications requiring live tissue, such as ex vivo drug response determination in various precision oncology applications.

### SUMMARY

One aspect of the present disclosure provides a system comprising a mold including a cavity at least partially formed by a surface and a wall. A trough is formed in the surface, the trough is configured to support a sample therein, and a plurality of openings is formed in the trough. The system further comprises a holder including a frame and a scaffold positioned within the frame. The frame is receivable within the cavity.

In some embodiments, the surface is planar and the wall is a circumferential wall.

In some embodiments, the trough includes a first surface, a second surface, and a transition surface positioned between the first surface and the second surface.

In some embodiments, a plane defined by the first surface and a plane defined by the second surface intersect at an angle; wherein the angle is within a range of 60 degrees to 120 degrees.

In some embodiments, the transition surface is arcuate.

In some embodiments, the plurality of openings is formed in the first surface and the second surface.

In some embodiments, each of the plurality of openings is a slot that extends between the first surface and the second surface.

In some embodiments, the frame is receivable within the cavity in only a first orientation and a second orientation.

In some embodiments, the mold further includes a protrusion that extends from the wall; and wherein the frame of the holder includes an outer surface with a first groove and a second groove formed in the outer surface; and wherein the protrusion is received within the first groove or the second groove.

In some embodiments, the holder further includes a stem and a transition portion positioned between the frame and the stem.

In some embodiments, a thread is formed on an outer circumferential surface of the stem; and wherein the stem is hollow; and wherein the system further comprises a locking nut coupled to the thread formed on the stem.

In some embodiments, the transition portion includes an orienting flange and a fiducial.

In some embodiments, the scaffold is a gyroid lattice.

In some embodiments, the scaffold is a lattice of cones.

In some embodiments, the mold further includes a base having an outer circumferential surface, and a vent formed in the outer circumferential surface.

In some embodiments, the mold further includes a grip member positioned on the outer circumferential surface.

In some embodiments, the mold further includes a rib extending from the trough and an inner circumferential surface of the base.

In some embodiments, the mold further includes a ridge; and wherein the frame of the holder abuts the ridge when the frame is received within the cavity.

In some embodiments, the system further comprises a waste tube; and wherein a base of the mold is receivable within the waste tube.

In some embodiments, the system further comprises a sample tube including a sample in a liquid; and wherein the liquid drains through the plurality of openings as the sample is positioned within the trough of the mold.

In some embodiments, the system further comprises an embedding agent positioned within the cavity.

Another aspect of the present disclosure provides a method comprising pouring a sample and a liquid into a mold that is coupled to a waste tube; wherein the sample is supported within a trough formed in the mold and the liquid passes into the waste tube through a plurality of openings formed in the trough; adding an embedding agent in a liquid state to the mold; inserting a holder into the mold; wherein a portion of the embedding agent is received within a frame of the holder; removing the waste tube from the mold; solidifying the embedding agent to semi-solid state in the mold and the holder such that the embedding agent at least partially surrounds the sample and forms a mechanical connection with the holder; and removing the holder from the mold; wherein the sample and the embedding agent are retained on the holder.

In some embodiments, the sample is a live tissue sample.

In some embodiments, the live tissue sample is a biopsy that defines a sample axis; and wherein the sample axis is aligned with a trough axis upon pouring the sample and the liquid into the mold.

In some embodiments, pouring the sample and the liquid is from a sample tube.

In some embodiments, the sample is oriented within the trough as the liquid is being poured into the mold without any additional physical manipulation by the operator.

In some embodiments, the embedding agent is agarose.

In some embodiments, the embedding agent has a greater viscosity than the liquid.

In some embodiments, inserting the holder into the mold is in a first orientation for a first cutting procedure or a second orientation for a second cutting procedure.

In some embodiments, solidifying the embedding agent includes positioning the mold and the holder in a cooling station.

In some embodiments, the mechanical connection includes the embedding agent positioned within a scaffold of the holder.

In some embodiments, removing the holder from the mold creates a sample assembly including the holder, the sample, and the embedding agent.

In some embodiments, the sample is retained on the holder in a triangular-shaped body of the embedding agent.

In some embodiments, the triangular-shaped body is a prism.

In some embodiments, the method further comprises securing the sample assembly to a cutting assembly and cutting the sample.

In some embodiments, securing the sample assembly to the cutting assembly includes inserting the sample assembly within a slot formed in the cutting assembly and attaching a locking nut to the holder.

Another aspect of the present disclosure provides a method comprising attaching a sample assembly to a mount of a cutting assembly; wherein the sample assembly includes a sample supported in an embedding agent; and wherein the cutting assembly includes a blade holder, a first blade coupled to the blade holder, and a second blade coupled to the blade holder; cutting the sample and the embedding agent with the first blade along a scoring cut to create an oblique slice; wherein the scoring cut is non-orthogonal to an axis of the sample; and removing the oblique slice from a remaining portion of the embedding agent by cutting the embedding agent with the second blade to create a separated oblique slice.

In some embodiments, cutting the sample and the embedding agent with the first blade includes oscillating the blade holder along a first axis and moving the mount along a second axis.

In some embodiments, the first axis is orthogonal to the second axis.

In some embodiments, cutting the embedding agent with the second blade includes oscillating the blade holder along the first axis and moving the mount along a third axis.

In some embodiments, the third axis is orthogonal to the second axis and the first axis.

In some embodiments, cutting the sample and the embedding agent with the first blade includes oscillating the blade holder at first oscillation rate; and cutting the embedding agent with the second blade includes oscillating the blade holder at a second oscillation rate lower than the first oscillation rate.

In some embodiments, the first oscillation rate is 80 Hz and the second oscillation rate is 10 Hz.

In some embodiments, the sample is live tissue biopsy.

In some embodiments, the separated oblique slice is supported on the second blade upon being removed from the remaining portion of the embedding agent.

In some embodiments, the method further comprises transferring the separated oblique slice on the second blade to a collection dish positioned on the mount.

In some embodiments, the method further comprises attaching the blade holder, a cover, and a lock to the cutting assembly.

In some embodiments, the first blade is angled relative to a vertical axis and the second blade is angled relative to a horizontal axis when the blade holder is mounted on the cutting assembly.

In some embodiments, a depth of the scoring cut is within a range of 1.5 mm to 4 mm.

In some embodiments, the method further comprises moving the blade holder to be received at least partially within a recess such that the first blade and the second blade are not exposed.

In some embodiments, the sample assembly includes the sample supported in a triangular shaped body of embedding agent.

In some embodiments, the scoring cut is one of a plurality of parallel scoring cuts; and wherein the oblique slice is one of a plurality of oblique slices; and wherein cutting the sample and the embedding agent with the first blade is along the plurality of scoring cuts to create the plurality of oblique slices; wherein each of the plurality of parallel scoring cuts is non-orthogonal to the axis of the sample.

In some embodiments, the method further comprises removing the plurality of oblique slices from the remaining portion of the embedding agent by cutting the embedding agent with the second blade to create a plurality of separated oblique slices.

In some embodiments, the plurality of oblique slices are removed with a plurality of passes of the second blade, wherein each of the plurality of oblique slices is removed with one of the plurality of passes; and wherein the second blade is offset between each of the plurality of passes such that the plurality of oblique slices are collected on the second blade with adjacent ones of the plurality of oblique slices positioned adjacent on the second blade.

In some embodiments, the entire sample is scored with the plurality of parallel scoring cuts to create a scored sample consisting of the plurality of oblique slices.

In some embodiments, removing the scored sample comprises separating all the plurality of oblique slices from the remaining portion of the embedding agent with one pass of the second blade.

Another aspect of the present disclosure provides a blade assembly comprising a body including a blade mount surface, a blade coupled to the blade mount surface; and a cover removably coupled to the body. The cover includes a latch and an aperture. The blade assembly is movable between a first configuration and a second configuration. In the first configuration, the cover is coupled to the body and positioned over the blade. In the first configuration, the latch abuts the body. In the second configuration, the cover is removed from the body and the blade is exposed. The latch is movable with respect to the body in response to insertion of a key into the aperture.

In some embodiments, the body includes a mounting aperture with a plurality of protrusions extending radially inward from the mounting aperture.

In some embodiments, each of the plurality of protrusions includes a ramped surface.

In some embodiments, the mounting aperture defines an axis; and wherein the axis is spaced from the blade.

In some embodiments, the blade mount surface is at a first end of the body; and wherein the body includes a detent channel formed at a second end of the body, opposite the first end.

In some embodiments, the aperture is positioned between the blade mount surface and the detent channel.

In some embodiments, the body includes a locking ledge; and wherein the latch abuts the locking ledge in the first configuration.

In some embodiments, the blade defines a cutting plane; and wherein the cutting plane intersects the cover in the first configuration.

In some embodiments, the cover includes a cover body, and wherein the latch includes an anchor secured to the cover body; and wherein the aperture is formed in the cover body.

In some embodiments, the aperture defines an axis; wherein the axis is spaced from the blade.

In some embodiments, the latch includes an arm with a first portion and a second portion formed on an inner surface of the arm; wherein in the first configuration, the first portion abuts the body, and the second portion extends into the aperture.

In some embodiments, the aperture is a first aperture, and the axis is a first axis; and wherein the cover further includes a second aperture formed in the cover body; wherein the second aperture defines a second axis; wherein the second axis is spaced from and parallel to the first axis.

In some embodiments, the latch includes a first arm, a second arm, and an intermediate portion extending between the first arm and the second arm; wherein the first arm includes a first portion and a second portion formed on a first inner surface of the first arm; wherein the second arm includes a third portion and a fourth portion formed on a second inner surface of the second arm; and wherein in the first configuration, the first portion and the third portion abut the body, the second portion extends into the first aperture, and the fourth portion extends into the second aperture.

In some embodiments, the anchor extends from the intermediate portion.

Another aspect of the present disclosure provides a cutting assembly comprising a blade assembly with a blade and a cover, and a blade assembly mount. The blade assembly is removably coupled to the blade assembly mount without the use of tools. The cutting assembly further comprises a sample mount configured to receive a sample assembly to be processed by the blade; and a cover key. The cover key interfaces with the cover to remove the cover from the blade assembly.

In some embodiments, the blade assembly mount includes a boss extending from a surface; wherein the boss includes a plurality of protrusions that radially extend from a cylindrical surface; and wherein the blade assembly includes a mounting aperture with a plurality of protrusions that radially extend inward from the mounting aperture.

In some embodiments, the blade assembly is coupled to the blade assembly mount in response to a first movement of the blade assembly along an axis; and a second movement, after the first movement, of the blade assembly about the axis.

In some embodiments, the axis is aligned with the boss of the blade assembly mount.

In some embodiments, the blade assembly mount further includes a detent and the blade assembly includes a detent channel configured to receive the detent.

In some embodiments, the cover key is positioned on the sample mount.

In some embodiments, the cover key is a peg that extends from a front surface of the sample mount.

In some embodiments, the peg includes a reduced diameter portion spaced from a distal end of the peg.

In some embodiments, the cover includes a latch and an aperture; wherein the latch abuts the reduced diameter portion when the peg is inserted into the aperture.

In some embodiments, the sample mount includes a slot formed in the front surface; wherein the slot is configured to receive a sample assembly to be processed by the blade.

Another aspect of the present disclosure provides a method comprising attaching a sample assembly to a sample mount; attaching a blade assembly to a blade assembly mount; wherein the blade assembly includes a blade and a cover positioned over the blade; and initiating at least one processing step of the sample assembly with the blade to generate a processed sample assembly without contacting the cover.

In some embodiments, the method further comprises removing the blade assembly from the blade assembly mount, wherein the cover is positioned over the blade when the blade assembly is removed; and wherein the contacting the cover is not required.

In some embodiments, the method further comprises removing the processed sample assembly from the sample mount after the blade assembly is removed from the blade assembly mount.

In some embodiments, attaching the blade assembly to the blade assembly mount includes moving the blade assembly in a first direction along a first axis; and moving the blade assembly in a second direction about the first axis.

In some embodiments, initiating the at least one processing step includes closing a door on an enclosure or providing a user-input.

Another aspect of the present disclosure provides a method comprising receiving a sample assembly on a sample mount; receiving a blade assembly on a blade assembly mount; wherein the blade assembly includes a blade and a cover positioned over the blade; receiving a user input to initiate at least one processing step of the sample assembly with the blade; removing the cover from the blade; performing the at least one processing step of the sample assembly with the blade to generate a processed sample assembly; and reattaching the cover to the blade.

In some embodiments, removing the cover from the blade includes inserting a cover key into an aperture in the cover.

In some embodiments, the cover key is positioned on the sample mount.

In some embodiments, inserting the cover key into the aperture is along a first axis.

In some embodiments, removing the cover from the blade further includes moving the blade with respect to the cover along a second axis while the cover key is in the aperture; wherein the second axis is orthogonal to the first axis.

In some embodiments, reattaching the cover to the blade includes moving the blade with respect to the cover along the second axis while the cover key is in the aperture.

In some embodiments, the method does not require any human interaction with the cover or the blade.

Other aspects of the disclosure will become apparent by consideration of the detailed description and accompanying drawings.

### BRIEF DESCRIPTION OF THE DRAWINGS

These and other features, aspects, and advantages of the present technology will become better understood with regards to the following drawings. The accompanying figures and examples are provided by way of illustration and not by way of limitation.

FIG. 1 is a perspective view of a sample assembly mounted on a cutting assembly.

FIG. 2 is a partial perspective view of the sample assembly mounted on the cutting assembly of FIG. 1.

FIG. 3 is a partial top view of the sample assembly mounted on the cutting assembly of FIG. 1.

FIG. 4 is a partial cross-sectional side view of the sample assembly mounted on the cutting assembly of FIG. 1.

FIG. 5 is a perspective view of a sample encasing system.

FIG. 6 is a perspective view of a portion of the sample encasing system of FIG. 5.

FIG. 7 is a top perspective view of a mold of the sample encasing system of FIG. 5.

FIG. 8 is a bottom perspective view of the mold of FIG. 7.

FIG. 9 is a top view of the mold of FIG. 7.

FIG. 10 is a perspective view of a sample assembly.

FIG. 11 is a top perspective view of a holder of the sample assembly of FIG. 10.

FIG. 12A is a partial top perspective view of a holder.

FIG. 12B is a partial cross-sectional perspective view of the holder of FIG. 12A.

FIG. 13 is a partial top perspective view of a holder.

FIG. 14 is a flowchart of a method of encasing a sample.

FIG. 15A is a perspective view of a blade holder assembly.

FIG. 15B is an exploded view of the blade holder assembly of FIG. 15A.

FIG. 16A is a side view of a blade holder with a first blade and a second blade.

FIG. 16B is a side view of a blade holder with a first blade and a second blade.

FIG. 17 is a side view of a sample assembly and a blade holder assembly, indicating a scoring depth.

FIG. 18 is a top view of a sample assembly with a plurality of scoring cuts shown.

FIG. 19 is a top view of a sample with a plurality of scoring cuts to create oblique slices of the sample.

FIG. 20 is a side view of a sample assembly and a blade holder assembly, illustrating the step of removing a scored sample by separating the oblique slices from embedding agent with a blade (e.g., “bulk collection”).

FIG. 21A is a side view of a sample assembly and a blade holder assembly illustrating a step of cutting the sample and the embedding agent with a blade along a scoring cut to create an oblique slice.

FIG. 21B is a side view of a sample assembly and a blade holder assembly illustrating a step of cutting the embedding agent with a blade to create a separated oblique slice.

FIG. 21C is a side of a sample assembly and a blade holder assembly illustrating a step of removing the oblique slice.

FIG. 21D is a perspective view of FIG. 21C.

FIG. 22A is a side view of a sample assembly and a blade holder assembly illustrating a step of after scoring the sample.

FIG. 22B is a side view of a sample assembly and a blade holder assembly illustrating a step of cutting the embedding agent with a blade moving a first direction.

FIG. 22C is a side view of a sample assembly and a blade holder assembly illustrating a step of moving the blade in a second direction.

FIG. 22D is a side view of a sample assembly and a blade holder assembly illustrating removing an oblique slice from the embedding agent.

FIG. 23A is a perspective view of a sample assembly and a blade holder assembly, illustrating a step of removing a first oblique slice.

FIG. 23B is a perspective view of the sample assembly and the blade holder assembly of FIG. 23A, illustrating a step of removing a second oblique slice.

FIG. 23C is a perspective view of the sample assembly and the blade holder assembly of FIG. 23B, illustrating a step of removing a third oblique slice.

FIG. 24 is a flowchart of a method of cutting a sample.

FIG. 25 is a front perspective view of a blade assembly including a cover.

FIG. 26 is a front view of the blade assembly of FIG. 25.

FIG. 27 is a rear perspective view of the blade assembly of FIG. 25, with the cover removed.

FIG. 28 is a perspective view of a blade assembly mount.

FIG. 29 is a perspective view of the blade assembly of FIG. 25 coupled to the blade assembly mount of FIG. 28.

FIG. 30 is a perspective cross-sectional view of the blade assembly of FIG. 25 and a cover key.

FIGS. 31A-31J illustrate a process including steps performed by a user and steps performed by a cutting assembly.

FIG. 31A is a perspective view of a cutting assembly including a blade assembly mount and a sample mount.

FIG. 31B is a perspective view illustrating a step of coupling a sample assembly to a sample mount.

FIG. 31C is a perspective view illustrating a step of moving the blade assembly mount relative to the sample mount.

FIG. 31D is a perspective view of a step of attaching a blade assembly to the blade assembly mount.

FIG. 31E is a perspective view of the step of attaching the blade assembly to the blade assembly mount by moving the blade assembly along a first axis.

FIG. 31F is a perspective view of the step of attaching the blade assembly to the blade assembly mount by moving the blade assembly about the first axis.

FIG. 31G is a perspective view of a step of removing a cover from the blade assembly by inserting a cover key into the cover.

FIG. 31H is a perspective view of the step of removing the cover from the blade assembly by moving the blade relative to the cover while the cover key is positioned within the cover.

FIG. 31I is a perspective view of a step of moving the blade assembly mount relative to the sample mount after the cover has been removed from the blade assembly.

FIG. 31J is a perspective view of a step of performing a processing step of the sample assembly.

FIG. 32 is a flowchart of a method of initiating a processing step of a sample assembly without contacting the cover.

FIG. 33 is a flowchart of a method of removing and reattaching a cover from a blade and performing a processing step to a sample assembly.

Before any embodiments are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

### Definitions

The singular forms “a” “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. Unless otherwise indicated, all numbers expressing quantities of ingredients, properties such as molecular weight, reaction conditions, so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least each numerical parameter should at least be construed in light of the number of reported significant digits and by applying ordinary rounding techniques.

The phrase “and/or,” as used herein in the specification and in the claims, should be understood to mean “either or both” of the elements so conjoined, e.g., elements that are conjunctively present in some cases and disjunctively present in other cases.

Use of ordinal terms such as “first,” “second,” “third,” etc., in the claims or specification to modify an element does not by itself connote any priority, precedence, or order of one claim element over another or the temporal order in which acts of a method are performed but are used merely as labels to distinguish one element having a certain name from another element having the same name.

The term “coupled,” as used herein, is defined as “connected,” although not necessarily directly, and not necessarily mechanically. The term coupled is to be understood to mean physically, magnetically, chemically, electrically, or otherwise coupled, connected or linked and does not exclude the presence of intermediate elements between the coupled elements absent specific contrary language.

The term “configured to” describes hardware, software or a combination of hardware and software that is adapted to, set up, arranged, commanded, altered, modified, built, composed, constructed, designed, or that has any combination of these characteristics to carry out a given function.

“Subject” as used herein is any mammalian or non-mammalian subject. In some embodiments, the subject is a human subject. In some embodiments, the subject is suspected of or diagnosed with cancer. The cancer can be any solid or hematologic malignancy. The cancer can be of any stage and/or grade. Non-limiting examples of cancer include cancers of head & neck, oral cavity, breast, ovary, uterus, gastro-intestinal, colorectal, pancreatic, prostate, brain and central nervous system, skin, thyroid, kidney, bladder, lung, liver, bone and other tissues.

“Tissue” or “tissue sample” as used interchangeably herein, is a biological material obtained from a subject. The tissue can be from any organ or site in the body of the subject. A tissue can be obtained from a subject by any approach known to a person skilled in the art. The tissue can be obtained by surgical resection, surgical biopsy, investigational biopsy or any other therapeutic or diagnostic procedure performed on a subject. In some embodiments, the tissue contains or is suspected to contain tumor cells. The terms tumor cells, cancerous cells, and malignant cells have been used interchangeably. In some embodiments, the tissue is a tumor tissue. In some embodiments, the tissue is obtained from any organ or site in the body of the subject where a cancer has originated or where the cancer has metastasized to. In some embodiments, the tissue may also contain immune cells, stromal cells etc. While the tissue can be in any form (such as frozen or fixed), in preferred embodiments, the tissue is a live, fresh tissue. In some embodiments, the tissue has not been subjected to any tissue fixation techniques known to a person of ordinary skill in the art (such as formalin treatment) or not been stored under any condition or for any duration of time to significantly reduce the number of viable cells. In some embodiments, the tissue sample is a biopsy sample that is a cylindrical sample of tissue that has been captured from the source by a specialized biopsy needle. In some embodiments, the biopsy sample is a core needle biopsy. In some embodiments, the biopsy is a forceps biopsy, a punch biopsy, or any other suitable biopsy type.

As used herein, the term “embedding agent” refers to a gel matrix that structurally and/or nutritionally supports the tissue. The embedding agent may include a nutritional composition to support the viability of the embedded tissue. In some embodiments, the embedding agent is agarose. In some embodiments, the embedding agent is 4% low-melting agarose mixed with RPMI. The embedding agent can be in a solution state (e.g., a liquid) or a semi-solid state (e.g., a gelatinous form).

As used herein, the term “embed” refers to encapsulation that also includes partial encapsulation.

As used herein, the term “oblique slice” refers to a slanting slice that is cut neither parallel nor at a right angle to a longitudinal axis defined by the whole.

As used herein, the term “processor” (e.g., a microprocessor, a microcontroller, a controller, a processing unit, or other suitable programmable device) can include, among other things, a control unit, an arithmetic logic unit (“ALC”), and a plurality of registers, and can be implemented using a known computer architecture (e.g., a modified Harvard architecture, a von Neumann architecture, etc.). In some embodiments the processor is a microprocessor that can be configured to communicate in a stand-alone and/or a distributed environment, and can be configured to communicate via wired or wireless communications with other processors, where such one or more processor can be configured to operate on one or more processor-controlled devices that can be similar or different devices.

As used herein, the term “memory” is any memory storage and is a non-transitory computer readable medium. The memory can include, for example, a program storage area and the data storage area. The program storage area and the data storage area can include combinations of different types of memory, such as a ROM, a RAM (e.g., DRAM, SDRAM, etc.), EEPROM, flash memory, a hard disk, a SD card, or other suitable magnetic, optical, physical, or electronic memory devices. The processor can be connected to the memory and execute software instructions that are capable of being stored in a RAM of the memory (e.g., during execution), a ROM of the memory (e.g., on a generally permanent bases), or another non-transitory computer readable medium such as another memory or a disc. In some embodiments, the memory includes one or more processor-readable and accessible memory elements and/or components that can be internal to the processor-controlled device, external to the processor-controlled device, and can be accessed via a wired or wireless network. Software included in the implementation of the methods disclosed herein can be stored in the memory. The software includes, for example, firmware, one or more applications, program data, filters, rules, one or more program modules, and other executable instructions. For example, the processor can be configured to retrieve from the memory and execute, among other things, instructions related to the processes and methods described herein.

As used herein, the term “network” generally refers to any suitable electronic network including, but not limited to, a wide area network (“WAN”) (e.g., a TCP/IP based network), a local area network (“LAN”), a neighborhood area network (“NAN”), a home area network (“HAN”), or personal area network (“PAN”) employing any of a variety of communications protocols, such as Wi-Fi, Bluetooth, ZigBee, etc. In some embodiments, the network is a cellular network, such as, for example, a Global System for Mobile Communications (“GSM”) network, a General Packet Radio Service (“GPRS”) network, an Evolution-Data Optimized (“EV-DO”) network, an Enhanced Data Rates for GSM Evolution (“EDGE”) network, a 3GSM network, a 4GSM network, a 5G New Radio, a Digital Enhanced Cordless Telecommunications (“DECT”) network, a digital AMPS (“IS-136/TDMA”) network, or an Integrated Digital Enhanced Network (“iDEN”) network, etc. In some embodiments, systems comprise a computer and/or data storage provided virtually (e.g., as a cloud computing resource). In particular embodiments, the technology comprises use of cloud computing to provide a virtual computer system that comprises the components and/or performs the functions of a computer as described herein. Thus, in some embodiments, cloud computing provides infrastructure, applications, and software as described herein through a network and/or over the internet. In some embodiments, computing resources (e.g., data analysis, calculation, data storage, application programs, file storage, etc.) are remotely provided over a network (e.g., the internet).

### Overview

Disclosed herein are a set of tools and techniques for positioning and mounting a live tissue biopsy, for example, in embedding media. A cutting assembly is disclosed for sectioning and recovering sections of the mounted biopsy that maximizes the quantity, geometry, and viability of tissue available for imaging under multiple modalities. The disclosed methods and systems address multiple problems associated with both the embedding of live tissue and the generation of sections. The solutions disclosed herein improve the ability to render viable and oblique sections of tissue from viable biopsy tissue for the purpose of imaging, for example.

### Sample Embedding System and Method

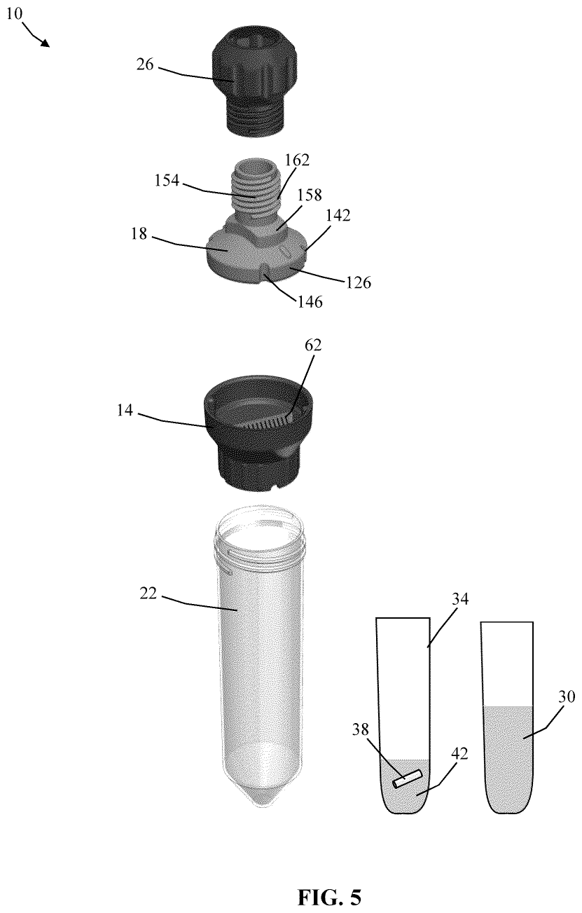

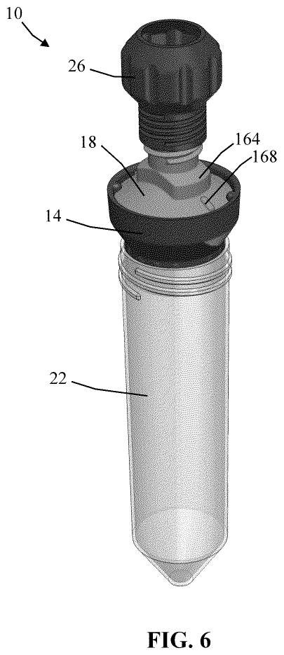

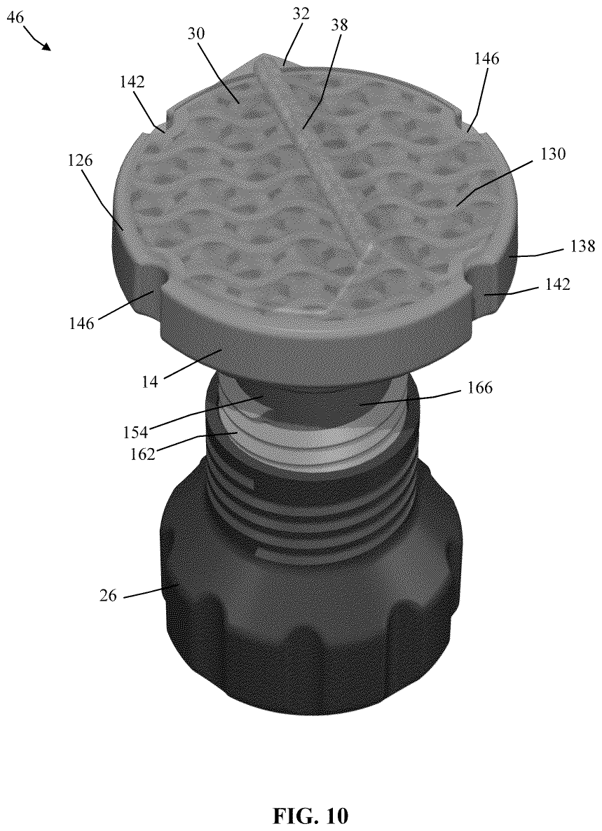

With reference to FIGS. 5 and 6, an embedding system 10 is illustrated with a mold 14, a holder 18, a waste tube 22, a locking nut 26, an embedding agent 30, and a sample tube 34 with a sample 38 in a liquid 42 (e.g., a low viscosity suspension liquid, RPMI, DPBS, etc.). The embedding system 10 is utilized to generate a sample assembly 46 (FIG. 10) with the sample 38 embedded within the embedding agent 30 and coupled to the holder 18. As an overview, the sample 38 and the liquid 42 are poured into the mold 14 and the liquid 42 flows through the mold 14 into the waste tube 22. As the liquid 42 flows through the mold 14, the sample 38 is aligned in a desired orientation at the bottom of the mold 14. Then, the embedding agent 30 in a liquid state is poured into the mold 14 and the holder 18 is positioned within the mold 14. As detailed further herein, once the embedding agent 30 solidifies to a semi-solid state, the holder 18 anchors the sample 38 through the embedding agent 30 to create the sample assembly 46 (FIG. 10) with precise repeatable geometry for interfacing with a cutting assembly (e.g., the cutting assembly 310).

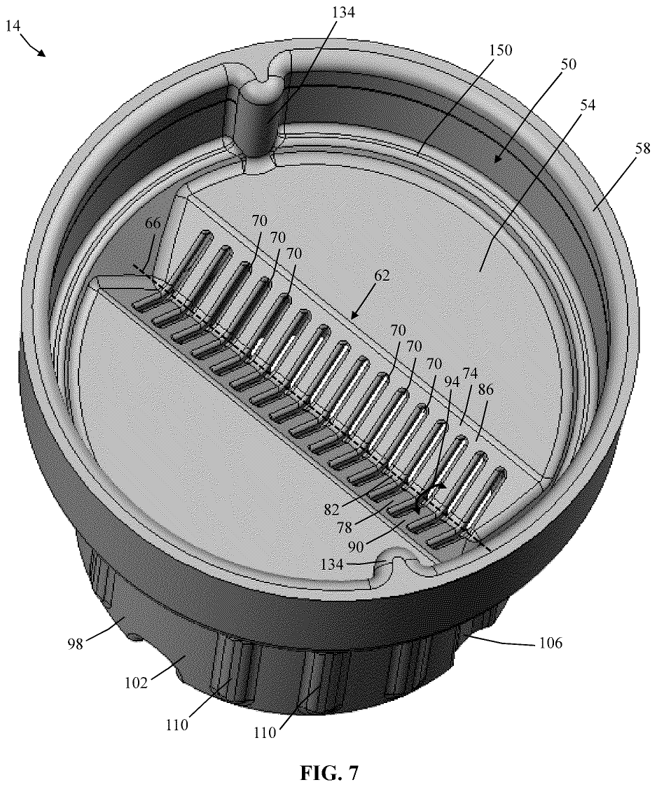

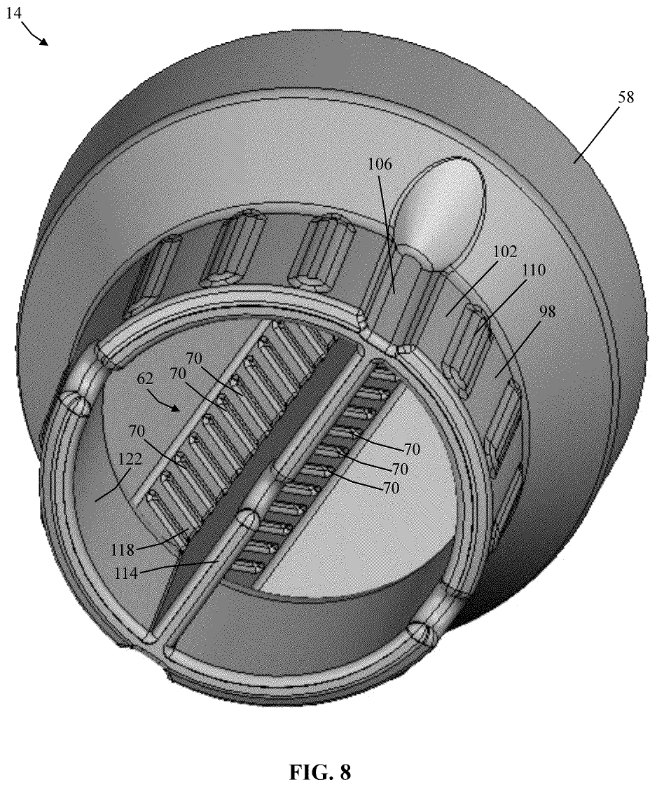

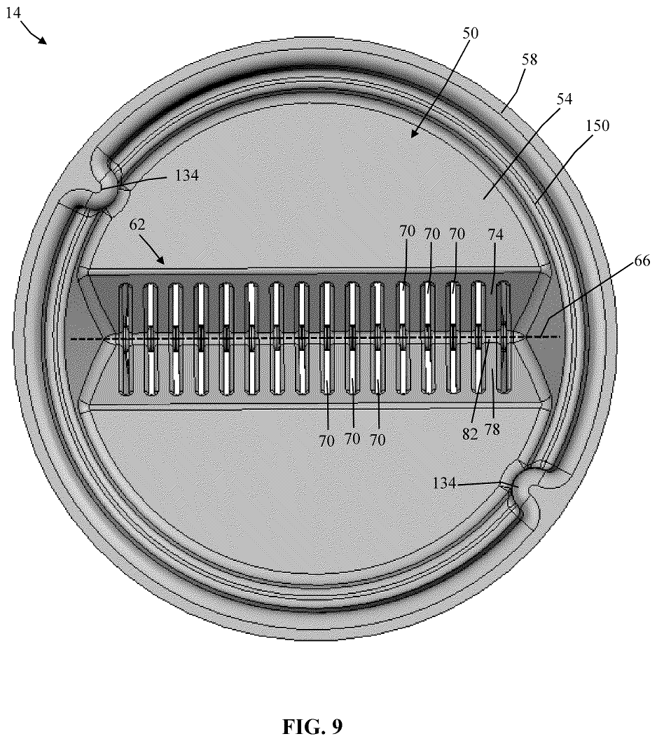

With reference to FIGS. 7-9, the mold 14 includes a cavity 50 at least partially formed by a surface 54 and a wall 58. A trough 62 is formed in the surface 34 and extends along a trough axis 66. As detailed herein, the trough 62 is configured to drain the liquid 42 and to support the sample 38 therein. A plurality of openings 70 is formed in the trough 62. In the illustrated embodiment, the surface 54 is planar and the wall 58 is a circumferential side wall. The trough 62 includes a first surface 74, a second surface 78, and a transition surface 82 positioned between the first surface 74 and the second surface 78. In the illustrated embodiment, the transition surface 82 is arcuate. In the illustrated embodiment, a plane 86 is defined by the first surface 74 and a plane 90 is defined by the second surface 78. The plane 86 intersects the plane 90 at an angle 94. In some embodiments, the angle 94 is within a range of approximately 60 degrees to approximately 120 degrees. In the illustrated embodiment, the angle 94 is approximately 90 degrees.

With continued reference to FIGS. 7-9, the plurality of openings 70 is formed in the first surface 74 and the second surface 78. In the illustrated embodiment, each of the plurality of openings 70 is a slot that extends between the first surface 74, the transition surface 82, and the second surface 78. In the illustrated embodiment, the plurality of openings 70 is a plurality of parallel slots, with each slot extending perpendicular to the trough axis 66. In some embodiments, the plurality of openings 70 is arranged in a linear pattern along the trough axis 66. As explained in greater detail herein, the plurality of openings 70 is configured for the liquid 42 from the sample tube 34 to drain through the plurality of openings 70 as the sample 38 is positioned and oriented within the trough 62 of the mold 14. The plurality of openings 70 is also configured to at least partially retain the embedding agent 30 in the cavity 50 of the mold 14 when the embedding agent 30 is poured in a liquid state into the cavity 50 of the mold 14. For example, differences in viscosity may allow the liquid 42 to pass through the plurality of openings 70 but retain the embedding agent 30 in a liquid state. In other words, an increase in liquid viscosity changes the function of the mold 14 from a filter to an effectively closed cavity for molding an embedding agent.

With continued reference to FIGS. 7-9, the mold 14 includes a base 98 having an outer circumferential surface 102 and a vent 106 formed in the outer circumferential surface 102. The base 98 of the mold 14 is receivable within the waste tube 22 (FIG. 6). Advantageously, the vent 106 permits air to escape from the waste tube 22 when the mold 14 is coupled to the waste tube 22 to improve draining of the liquid 42 through the plurality of openings 70 in the trough 62. The mold 14 further includes at least one grip member 110 positioned on the outer circumferential surface 102. The grip member 110 advantageously provides a press-fit interface between the mold 14 and the waste tube 22. In the illustrated embodiment, the mold 14 further includes a rib 114 extending between a bottom 118 of the trough 62 and an inner circumferential surface 122 of the base 98. In some embodiments, the rib 114 improves the strength and the ability to additively manufacture the mold 14.

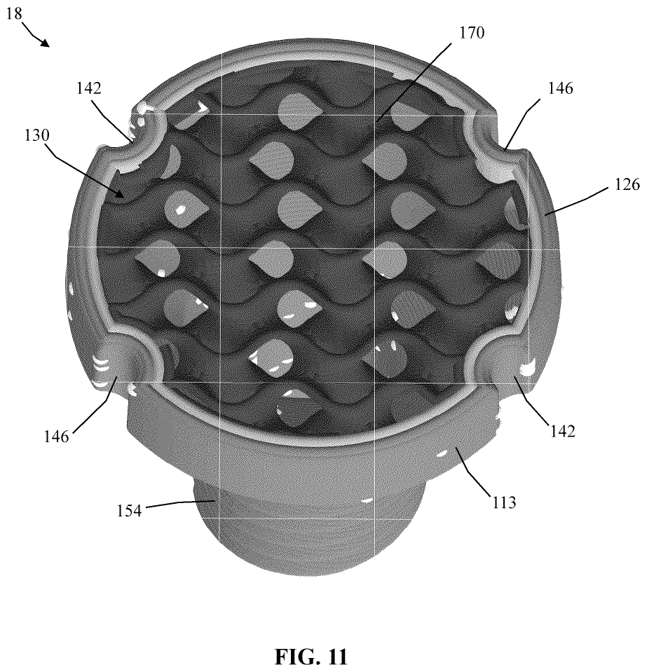

With reference to FIGS. 6 and 11, the holder 18 includes a frame 126 and a scaffold 130 positioned within the frame 126. The frame 126 is receivable within the cavity 50 of the mold 14. In the illustrated embodiment, the frame 126 is receivable within the cavity 50 only in a first orientation and a second orientation. The mold 14 further includes a protrusion 134 that extends from the wall 58, and the frame 126 of the holder 18 includes an outer surface 138 with a first groove 142 and a second groove 146 formed in the outer surface 138. The protrusion 134 is received within the first groove 142 in the first orientation or in the second groove 146 in the second orientation. In the illustrated embodiment, the mold 14 includes a ridge 150 and the frame 126 of the holder 18 abuts the ridge 150 when the frame 126 is received within the cavity 50.

With continued reference to FIG. 6, the holder 18 further includes a stem 154 and a transition portion 158 positioned between the frame 126 and the stem 154. In the illustrated embodiment, the stem 154 is hollow. In the illustrated embodiment, a thread 162 is formed on an outer circumferential surface 166 of the stem 154. The locking nut 26 is coupled to the thread 162 formed on the stem 154 to, for example, secure the holder 18 to a cutting assembly (e.g., the cutting assembly 310). In the illustrated embodiment, the transition portion 158 includes an orienting flange 164 and a fiducial 168.

With reference to FIGS. 10 and 11, the scaffold 130 on the holder 18 is a gyroid lattice 170. In the illustrated embodiment, the gyroid lattice 170 is additively manufactured. Advantageously, the gyroid lattice 170 provides a non-tapered interface that allows minimal resistance when submerging in the aqueous embedding agent, and the gyroid lattice provides omni-directional surfaces to improve the strength of the mechanical connection and prevent the solidified embedding agent from dislodging or disengaging.

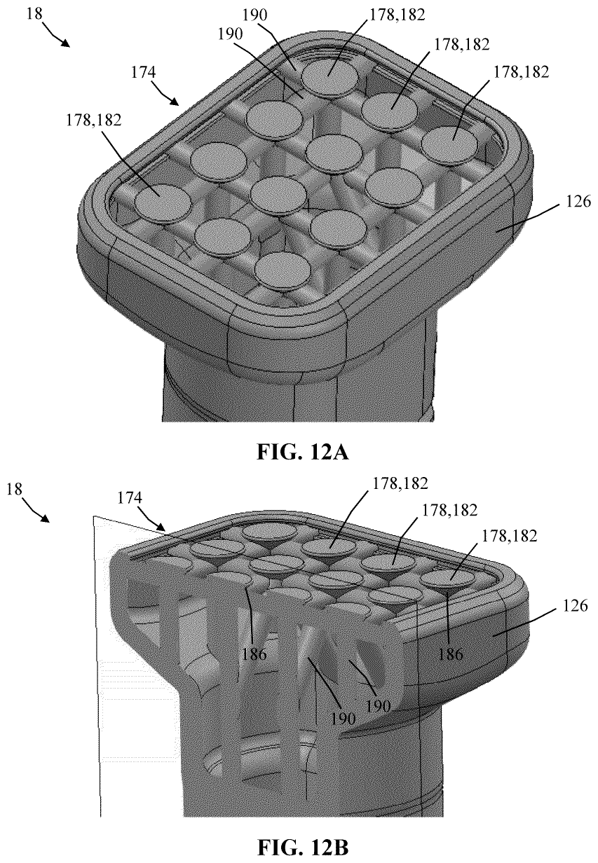

With reference to FIGS. 12A and 12B, the scaffold 130 on the holder 18 is a lattice of cones 174. In the illustrated embodiment, the lattice of cones 174 includes a plurality of cones 178 with planar bases 182 and conical surfaces 186. The plurality of cones 178 are interconnected, at least in part, by rods 190.

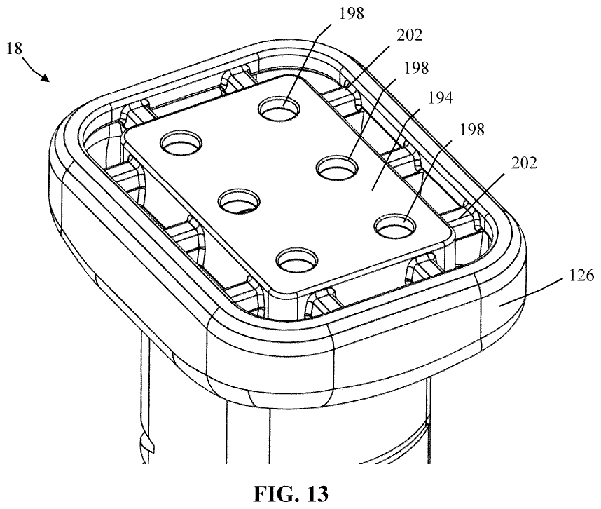

With reference to FIG. 13, the scaffold 130 on the holder 18 is planar surface 194 with a plurality of cylindrical bores 198 formed therein. In the illustrated embodiment, the planar surface 194 is supported and suspended in the center of the frame 126 with ribs 202.

With reference to FIG. 10, the sample assembly 46 includes the holder 18, the sample 38, and the embedding agent 30 in the semi-solid state formed in the shape of the negative of the cavity 50 of the mold 14. As detailed further herein, the sample 38 is advantageously oriented in the desired orientation to optimize, for example, downstream cutting procedures.

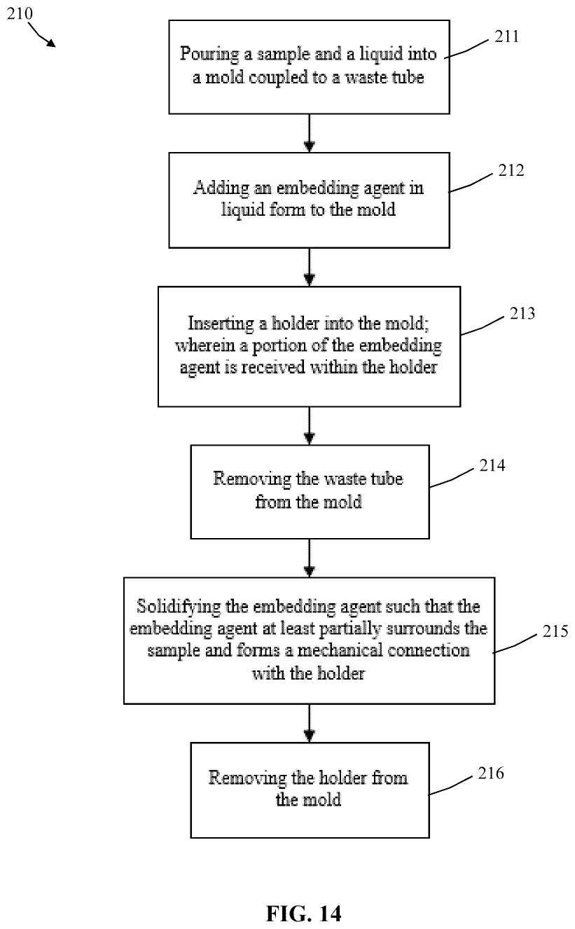

With reference to FIG. 14, a method 210 for embedding a sample using the embedding system 10 is illustrated. The method 210 includes (STEP 211) pouring the sample 38 and the liquid 42 into the mold 14 that is coupled to the waste tube 22. In the illustrated embodiment, the sample 38 and the liquid 42 are poured from the sample tube 34. The sample 38 is supported within the trough 62 formed in the mold 14 and the liquid 42 passes into the waste tube 22 through the plurality of openings 70 formed in the trough 62. In other words, the plurality of openings 70 in the mold 14 filter and allow the liquid 42 to drain from the bottom while retaining the sample 38. In some embodiments, the sample 38 is a live tissue sample. In some embodiments, the live tissue sample is a biopsy that defines a sample axis 40. In some embodiments, the sample 38 is a live tissue biopsy. In some embodiments, the sample 38 is a core needle biopsy. The sample axis 40 is aligned with the trough axis 66 upon pouring the sample 38 and the liquid 42 into the mold 14. In some embodiments, the sample 38 is oriented within the trough 62 as the liquid 42 is poured into the mold 14 without any additional physical manipulation by the operator. In other words, the sample 38 can be positioned in the desired orientation during the pouring step (STEP 211) by the flow of the liquid 42, and advantageously negates the need for a separate additional step to physically manipulate the sample 38 into the proper orientation.

The method 210 further includes (STEP 212) adding the embedding agent 30 in the liquid state to the mold 14. In some embodiments, the embedding agent 30 includes agarose (e.g., 4% agarose with RPMI). The plurality of openings 70 at least partially retains the embedding agent 30 in the mold 14 due to the viscosity of the embedding agent 30 and the embedding agent 30 transitioning from the liquid state to the semi-solid state upon entering the mold 14. In some embodiments, the viscosity of the embedding agent 30 in the liquid state at the time it is added to the mold 14 is within a range of approximately 5 centiposie (cP) to approximately 200 centiposie (cP). In some embodiments, the embedding agent 30 has a greater viscosity than the liquid 42. In some embodiments, the temperature of the embedding agent 30 in the liquid state at the time it is added to the mold 14 is within a range of approximately 35° C. to approximately 42° C. In some embodiments, the temperature of the embedding agent 30 in the liquid state at the time it is added to the mold 14 is within a range of approximately 37° C. to approximately 39° C.

The method 210 further includes (STEP 213) inserting the holder 18 into the mold 14 while the embedding agent 30 is still in the liquid state. In the illustrated embodiment, the holder 18 abuts the ridge 150 formed around the inner perimeter of the mold 14. The embedding agent 30 in the liquid state at least partially surrounds the exposed sides of the sample 38, which is still positioned in the trough 62. A portion of the embedding agent 30 in the liquid state is received within the frame 126 of the holder 18. In other words, excess embedding agent 30 in the liquid state is displaced through the scaffold 130 on the holder 18 when the holder 18 is inserted into the mold 14. In some embodiments, the holder 18 is inserted into the mold 14 in a first orientation corresponding to a first cutting procedure or a second orientation corresponding to a second cutting procedure. In other words, the holder 18 may be inserted into the mold 14 in one of two possible orientations depending on the desired cutting procedure to be used on the sample 38.

The method 210 further includes (STEP 214) removing the waste tube 22 including the liquid 42 from the mold 14. The waste tube 22 and the liquid 42 may be discarded.

The method 210 further includes (STEP 215) solidifying the embedding agent 30 to a semi-solid state in the mold 14 and the holder 18 such that the embedding agent 30 at least partially surrounds the sample 38 and forms a mechanical connection with the holder 18. In some embodiments, solidifying the embedding agent 30 includes positioning the mold 14 and the holder 18 in a cooling station (e.g., an ice tray or bath). In some embodiments, solidifying the embedding agent 30 includes positioning the mold 14 and the holder 18 at room temperature. In some embodiments, the solidifying step (STEP 215) is advantageously the only temperature change the sample 38 is subjected to throughout the entire method 210, which improves the viability of the sample 38. As the embedding agent 30 cools, the embedding agent 30 starts to solidify and becomes anchored to the scaffold 130 on the holder 18. In some embodiments, the mechanical connection includes the embedding agent 30 positioned within the scaffold 130 of the holder 18. In other words, the embedding agent 30 becomes interlinked with the scaffold 130 upon solidifying.

The method 210 further includes (STEP 216) removing the holder 18 from the mold 14 after the embedding agent 30 has solidified to an acceptable degree to create the sample assembly 46 where the sample 38 and the embedding agent 30 (now in the semi-solid state) are retained on the holder 18. The sample assembly 46 includes the holder 18, the sample 38, and the embedding agent 30 in the semi-solid state formed in the shape of the negative of the mold 14. In the illustrated embodiment, the sample 38 is retained on the holder 18 in the desired orientation within in a triangular-shaped body 32 of the embedding agent 30. In some embodiments, the triangular-shaped body 32 is shaped like a prism. Advantageously, the shape of the semi-solid form of the embedding agent 30 improves the vibrational response to, for example, an oscillating cutting blade. Advantageously, the method 210 does not require a sacrificial scaffold to hold the sample 38 in the desired position.

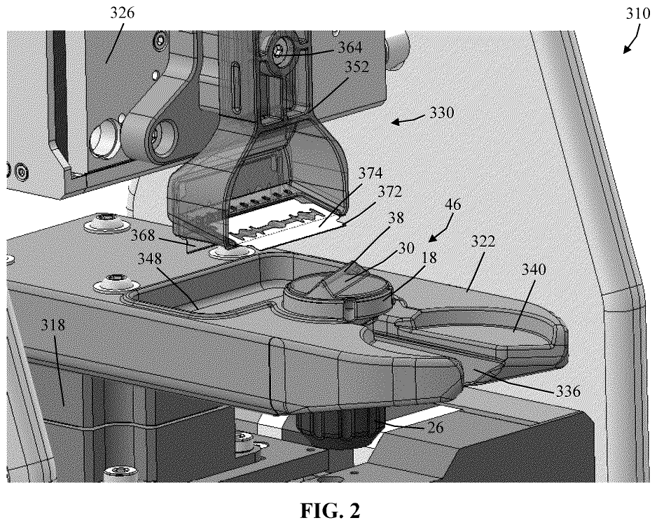

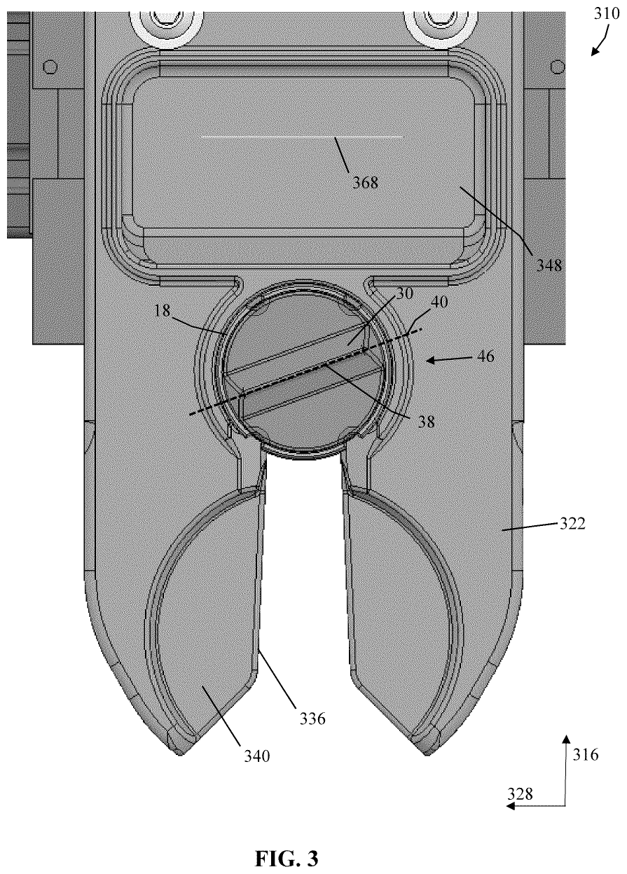

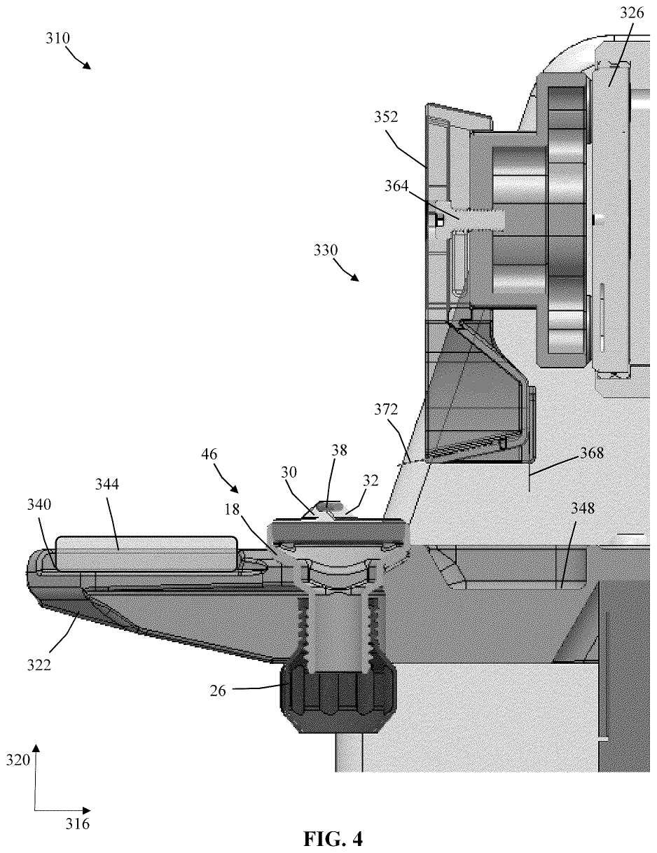

After the sample assembly 46 is created, the method 210 may further comprise securing the sample assembly 46 to a cutting assembly and cutting the sample 38. With reference to FIGS. 2-4, in some embodiments, securing the sample assembly 46 to the cutting assembly includes inserting the sample assembly 46 within a slot (e.g., slot 336) formed in the cutting assembly and attaching the locking nut 26 to the stem 154.

The embedding system 10 and the method 210 disclosed herein have several advantages. First, the embedding system 10 is configured to start with the sample tube 34 and efficiently separate the sample 38 from the liquid 42. Furthermore, the method 210 provides automatic or passive orientation, positioning, and straightening of the sample 38 in preparation for the embedding steps. In other words, the embedding system 10 and the method 210 orient the sample 38 suspended in the liquid 42 in a desired orientation by pouring the sample 38 and the liquid 42 into the mold 14 without additional physical manipulation of the sample 38. As another advantage, the embedding agent 30 in the semi-solid state supports, at least partially encases, and sustains the sample 38, which may be a live tissue biopsy. Furthermore, the sample 38 is supported in the desired orientation with precision and repeatability to optimize downstream cutting procedures. Finally, the sample assembly 46 resulting from the method 210 is configured to be secured with precision and repeatability to the cutting assembly to optimize downstream cutting procedures.

### Cutting Assembly and Method

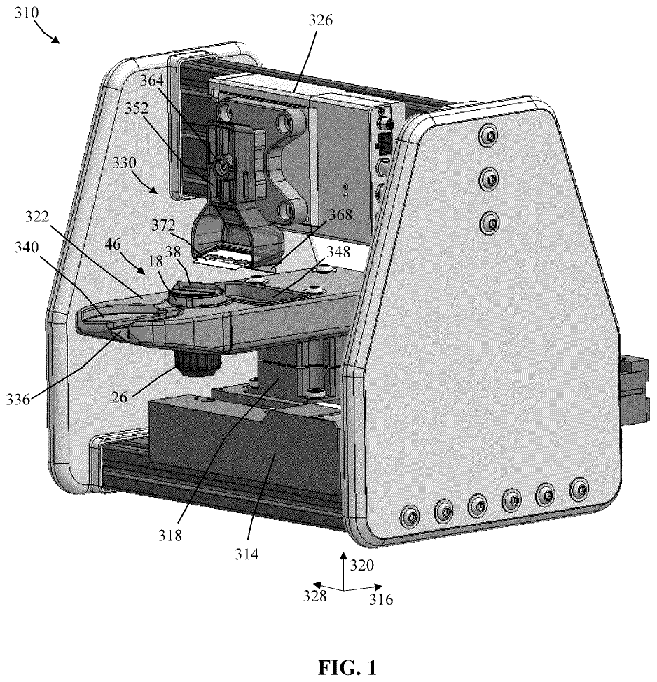

With reference to FIG. 1, a cutting assembly 310 includes an X-axis translation assembly 314, a Z-axis translation assembly 318, and a sample mount 322 coupled to the Z-axis translation assembly 318. In the illustrated embodiment, the Z-axis translation assembly 318 is carried on and movable by the X-axis translation assembly 314. As such, the X-axis translation assembly 314 and the Z-axis translation assembly 318 are configured to move the sample mount 322 along a X axis 316 and a Z axis 320. The X axis 316 is orthogonal to the Z axis 320.

The cutting assembly 310 further includes a Y-axis translation assembly 326 and a blade assembly 330 coupled to the Y-axis translation assembly 326. The Y-axis translation assembly 326 is configured to move the blade assembly 330 along a Y axis 328. The Y axis 328 is orthogonal to the X axis 316 and the Z axis 320.

In the illustrated embodiments, the X-axis translation assembly 314, the Z-axis translation assembly 318, and the Y-axis translation assembly 326 are motorized linear translation stages controlled by a processor. In the illustrated embodiment, the X-axis translation assembly 314 moves the sample mount 322 along the X axis 316 to a first position where the user may directly interact with the sample assembly 46 and the sample mount 322; and to a second position where the blade assembly 330 is positioned to interact with the sample assembly 46. In the illustrated, the Z-axis translation assembly 318 moves the sample mount 322 along the Z axis 320 which is vertically up and down and used, for example, to position the blade assembly 330 at desired depths relative to the sample assembly 46. In the illustrated embodiment, the Y-axis translation assembly 326 moves the blade assembly 330 along the Y axis 328 which is a cutting axis. Motion of the cutting assembly 310 or motion of the sample assembly 46 described herein may refer to relative motion achieved in any number of ways. For example, “raising” the blade assembly 330 relative to the sample assembly 46 may be achieved by lowering the sample assembly 46 along the Z axis 320 with the Z-axis translation assembly 318 while the position of the blade assembly 330 along the Z axis 320 remains the same.

With reference to FIGS. 1-4, the sample mount 322 includes a slot 336, a recess 340 configured to receive a collection dish 344 (e.g., a petri dish), and a recess 348 configured to receive at least a portion of the blade assembly 330. The sample assembly 46 is positioned within the slot 336 and secured to the sample mount 322 with the locking nut 26. In the illustrated embodiment, the orienting flange 164 on the sample assembly 46 only permits the sample assembly 46 to pass through the slot 336 and be secured to the sample mount 322 in one of two orientations. In other words, the orienting flange 164 prevents misalignment of the sample assembly 46 when the operator secures the sample assembly 46 to the cutting assembly 310.

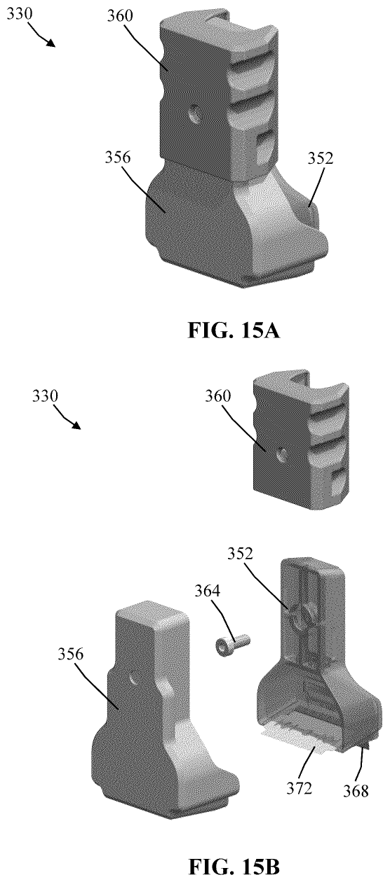

With reference to FIGS. 15A and 15B, the blade assembly 330 includes a blade holder 352, a cover 356, a lock 360, and a fastener 364. The blade holder 352 is secured to the Y-axis translation assembly 326 with the fastener 364. The cover 356 provides for safe handling of the blade assembly 330 during mounting and unmounting of the blade assembly 330 to the Y-axis translation assembly 326. In addition, in the illustrated embodiment, the lock 360 ensures the cover 356 remains in place until the operator is ready to remove the cover 356.

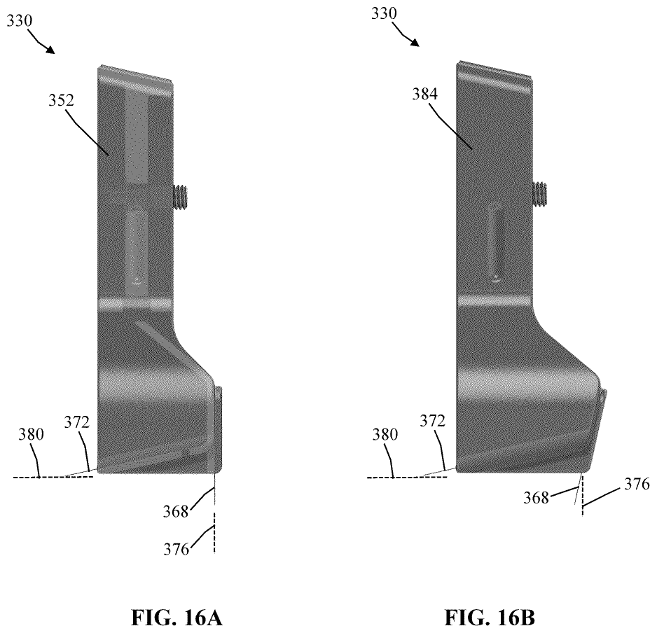

With reference to FIG. 16A, the blade assembly 330 further includes a first blade 368 coupled to the blade holder 352 and a second blade 372 coupled to the blade holder 352. In the illustrated embodiment, the first blade 368 is approximately aligned to a vertical axis 376 and the second blade 372 is angled relative to a horizontal axis 380 when the blade holder 352 is mounted on the Y-axis translation assembly 326. In some embodiments, the first blade 368 and the second blade 372 is a razor blade. The first blade 368 may be referred to herein as a vertical blade responsible for scoring the sample 38, and the second blade 372 may be referred to as an approximately horizontal blade responsible for slicing and separating slices of the sample 38.

With reference to FIG. 16B, the blade assembly 330 includes an alternative blade holder 384 with the first blade 368 coupled to the blade holder 384 and the second blade 372 coupled to the blade holder 384. In the illustrated embodiment, the first blade 368 is angled relative to the vertical axis 376 and the second blade 372 is angled relative to the horizontal axis 380 when the blade assembly 330 is mounted on Y-axis translation assembly 326. In the illustrated embodiment, both the first blade 368 and the second blade 372 are oriented at approximately 12.5 degrees relative to the direction of cutting.

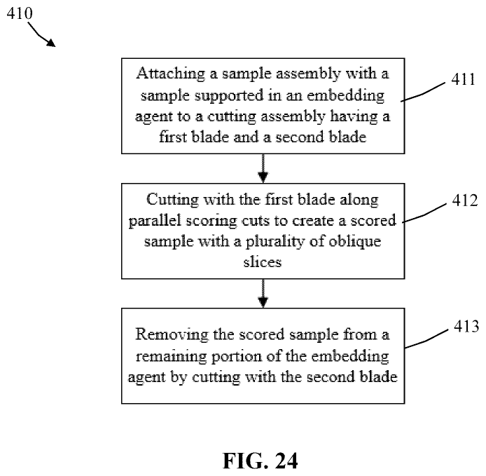

With reference to FIG. 24, a method 410 for cutting a sample (e.g., creating oblique slices of sample) is illustrated. The method 410 includes (STEP 411) attaching the sample assembly 46 to the sample mount 322 of the cutting assembly 310. As detailed herein, the sample assembly 46 includes the sample 38 supported in the embedding agent 30, and the cutting assembly 310 includes the blade holder 352, 384, the first blade 368 coupled to the blade holder 352, 384, and the second blade 372 coupled to the blade holder 352, 384. In the illustrated embodiment, the sample assembly 46 includes the sample 38 supported in the triangular shaped body 32 of the embedding agent 30.

In some embodiments, the method 410 further comprises attaching the blade assembly 330 including the blade holder 352, 384, the cover 356, and the lock 360 to the Y-axis translation assembly 326. Typically, attaching the blade assembly 330 occurs before (STEP 411) of attaching the sample assembly 46. In some embodiments, the method 410 further comprises moving the blade assembly 330 to be received at least partially within the recess 348 formed in the sample mount 322 such that the first blade 368 and the second blade 372 are not exposed. In other words, the method 410 may include moving the blade holder 352, 384, the first blade 368, and the second blade 372 to be at least partially positioned within the recess 348 to advantageously protect the operator from accidentally coming into contact with the blades. For example, the cutting assembly 310 may be configured to automatically positioned uncovered blades within the recess 348 for improved safety when the operator is prompted by the cutting assembly 310 to interact with portions of the sample assembly 46, the collection dish 344, or the cutting assembly 310.

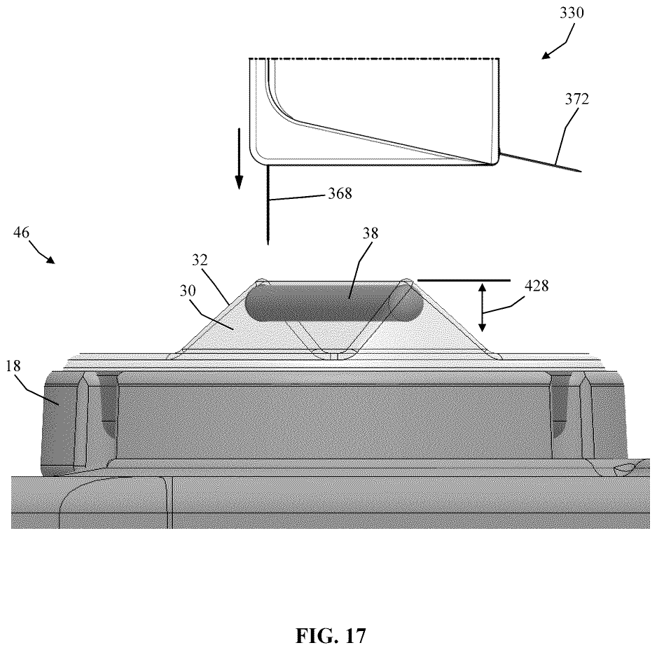

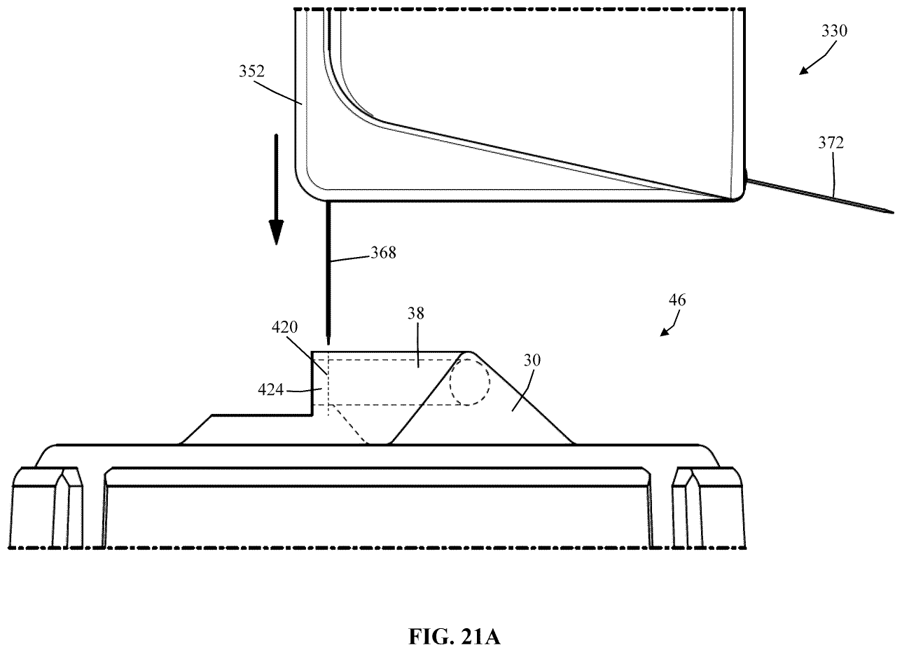

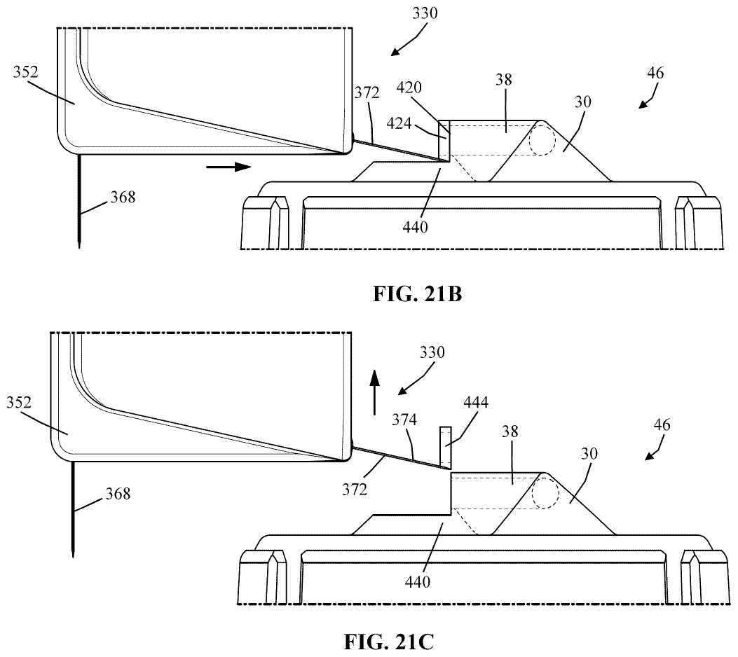

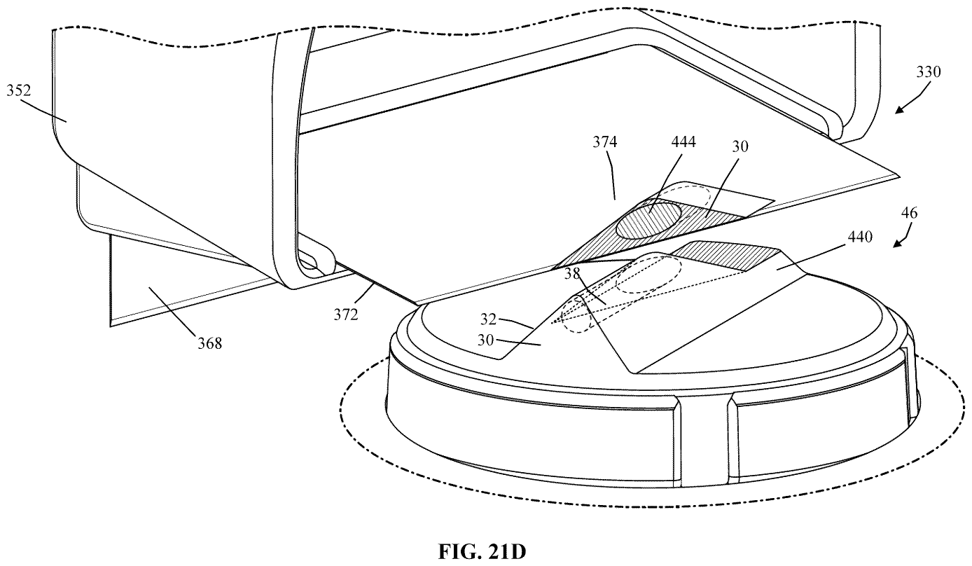

The method 410 further includes (STEP 412) cutting the sample 38 and the embedding agent 30 with the first blade 368 along a scoring cut 420 to create an oblique slice 424 (FIG. 21A). In the illustrated embodiment, the scoring cut 420 is non-orthogonal to the sample axis 40 of the sample 38. In some embodiments, (STEP 412) cutting the sample 38 and the embedding agent 30 with the first blade 368 includes oscillating the blade assembly 330 along the Y axis 328 and moving the sample mount 322 along the Z axis 320. In other words, the first blade 368 oscillates at a first oscillation rate along the Y axis 328 while the sample assembly 46 is moved vertically in the Z axis 320 to plunge the oscillating first blade 368 into the sample 38 and embedding agent 30 to a score depth 428 (FIG. 17). In some embodiments, the first oscillation rate is within a range of approximately 60 Hz to approximately 100 Hz. In some embodiments, the first oscillation rate is within a range of approximately 40 Hz to approximately 200 Hz. In some embodiments, the first oscillation rate is approximately 80 Hz. In some embodiments, the score depth 428 of the scoring cut 420 is within a range of approximately 1.5 mm to approximately 4 mm. The score depth 428 is adjustable depending on the size of the sample 38. For example, a small sample biopsy from a 19 G or 20 G needle may utilize a score depth of approximately 1.5 mm. As another example, a large sample biopsy from a 12 G or 14 G needle may utilize a score depth of approximately 4 mm. In some embodiments, the first blade 358 may be positioned in a starting position approximately 1 mm above the top of the sample assembly 46 to prevent scraping when repositioning.

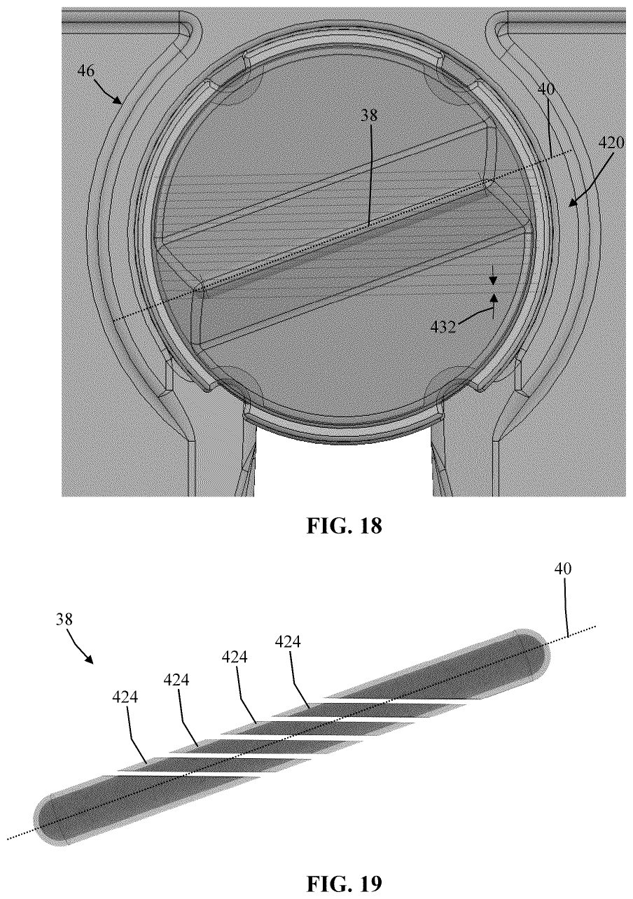

With reference to FIG. 18, and 19, the sample 38 and the embedding agent 30 is cut with the first blade 368 along a plurality of scoring cuts 420 to create a plurality of oblique slices 424. The plurality of oblique slices 424 advantageously balance tissue heterogeneity and tissue volume. Larger slices of tissue make it easier to manually manipulate the tissue after cutting, and fewer cut operations damage the tissue less. In addition, an approximately 20-degree slice, for example, fits into standard size wells plates and slides of imaging. It is also easier for operators to visually identify oblique slices compared to non-oblique slices without optical aids (e.g., microscopes) because of the larger size of an oblique slice. Advantages of oblique slices further include (1) increasing the amount of live tissue presented for imaging; (2) increasing the live slice or fragment yield from a given biopsy; and (3) preserves the largest fraction of intact living cells from the original sample. In the illustrated embodiment, each of the plurality of parallel scoring cuts 420 is non-orthogonal to the sample axis 40 of the sample 38. For example, a sample biopsy from an 18 gauge needle of approximately 800 μm by 5 mm is cut at a 20 degree angle relative to the longitudinal axis of the biopsy to yield 7 oval-shaped oblique slices approximately 0.8 mm by 2.9 mm.

A distance 432 between adjacent scoring cuts 420 may be adjustable or user-selectable to correspondingly adjust the thickness of the oblique slices 424. Any number of scoring cuts 420 may be made to the sample 38 with the first blade 368. For example, in one embodiment, 26 scoring cuts are made with approximately 300 μm between adjacent scoring cuts. In some embodiments, “N” number of scoring cuts are made to the sample with the first blade, where N is an integer greater than 0. In some embodiments, the entire sample 38 is scored with the plurality of parallel scoring cuts 420 to create a scored sample 436 (e.g., a completely scored sample) consisting of the plurality of oblique slices 424.

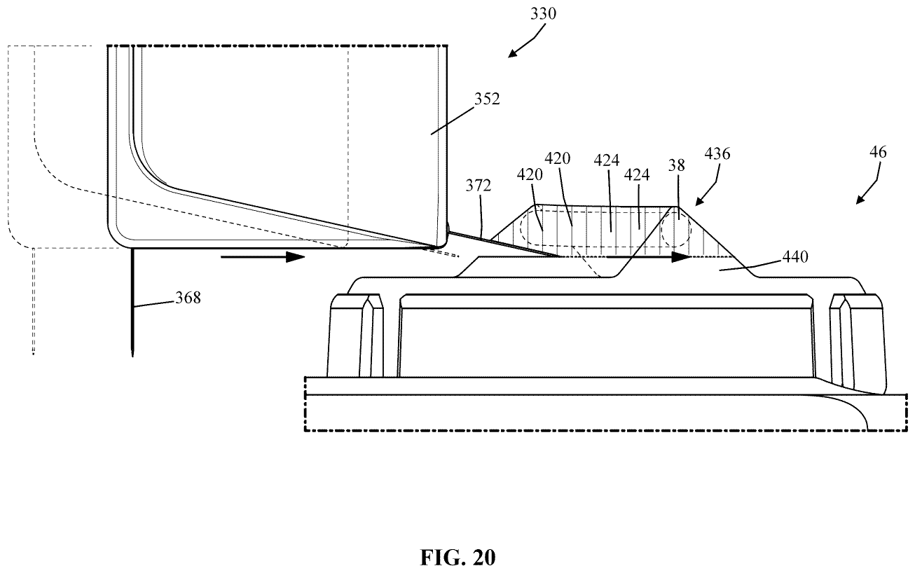

The method 410 further includes (STEP 413) removing the oblique slice 424 from a remaining portion 440 of the embedding agent 30 by cutting the embedding agent 30 with the second blade 372 to create a separated oblique slice 444 (FIG. 21B). In some embodiments, (STEP 413) cutting the embedding agent 30 with the second blade 372 includes oscillating the blade assembly 330 along the Y axis 328 and moving the sample mount 322 along the X axis 316. In other words, the second blade 372 oscillates at a second oscillation rate along the Y axis 328 while the sample assembly 46 is moved horizontally in the X axis 316 to cut the embedding agent 30 at a position below the sample 38 (FIG. 20, FIG. 21B). In some embodiments, the second blade 372 cuts the embedding agent 30 at a position slightly above the bottom of the scoring cut depth. In some embodiments, the second oscillation rate is within a range of approximately 5 Hz to approximately 15 Hz. In some embodiments, the second oscillation rate is approximately 10 Hz. In some embodiments, the second oscillation rate of the second blade 372 during (STEP 413) is lower than the first oscillation rate of the first blade 368 during (STEP 412). In some embodiments, the second oscillation rate is within a range of approximately 10% to approximately 30% of the first oscillation rate.

With reference to FIGS. 21C and 21D, the separated oblique slice 444 is supported on the second blade 372 upon being removed from the remaining portion 440 of the embedding agent 30. In the illustrated embodiment, the separated oblique slice 444 is supported on a top planar surface 374 of the second blade 372. In some embodiments, the method 410 further comprises transferring the separated oblique slice 444 on the second blade 372 to the collection dish 344 positioned on the sample mount 322. Advantageously, the method 410 preserves and provides information regarding where each removed oblique slice 424 comes from relative to the sample 38.

Any number of oblique slices 424 may be removed from the remaining portion 440 of the embedding agent 30 by cutting the embedding agent 30 with the second blade 372. In some embodiments, “M” number of oblique slices are removed with the second blade, where M is an integer greater than 0. In some embodiments, N number of scoring cuts is equal to M number of oblique slices removed. In some embodiments, M number of oblique slices removed is equal to N+1 number of scoring cuts made (e.g., in cases where the entire sample is removed).

Bulk Score and Collection. In some embodiments, the entire sample 38 is scored with the plurality of parallel scoring cuts 420 to create a scored sample 436 consisting of the plurality of oblique slices 424, and the removing the scored sample (STEP 413) comprises separating all of the plurality of oblique slices 424 from the remaining portion 440 of the embedding agent 30 with one pass of the second blade 372. In other words, the entire sample 38 is scored with a plurality of parallel scoring cuts 420 by the first blade 368 and then the entire scored sample 38 is removed in bulk by a single cut of the second blade 372.

N-number Score and Collection. In some embodiments, the sample 38 is partially scored with N-number of parallel scoring cuts 420 to create M-number of oblique slices 424, where M equals N. Any number of oblique slices 424 may be created and removed from the remaining portion 440 of the embedding agent 30 by scoring with the first blade 368 and removing with the second blade 372. In other words, the method 410 may further comprise removing the plurality of oblique slices 424 from the remaining portion 440 of the embedding agent 30 by cutting the embedding agent 30 with the second blade 372 to create a plurality of separated oblique slices 444.

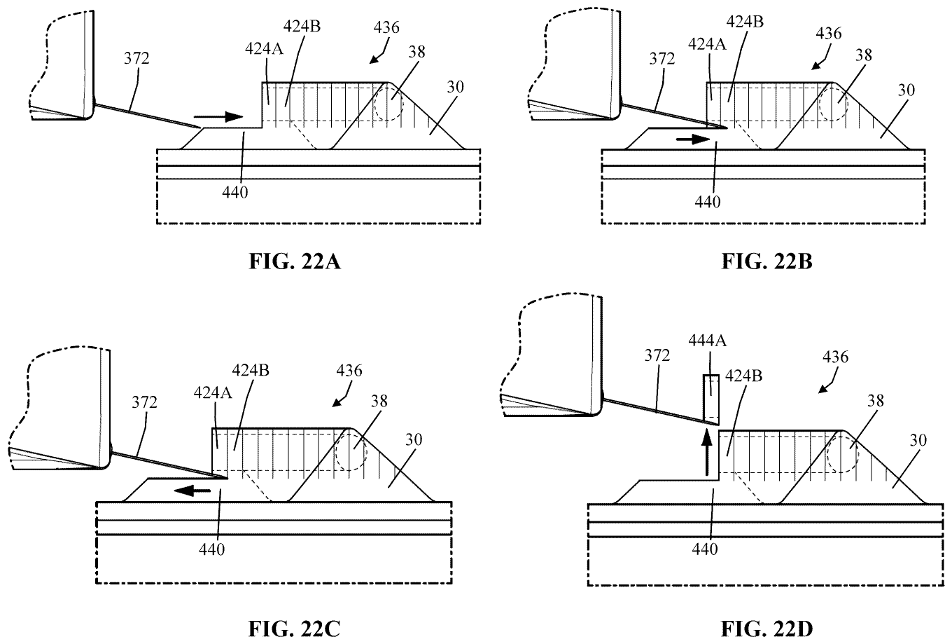

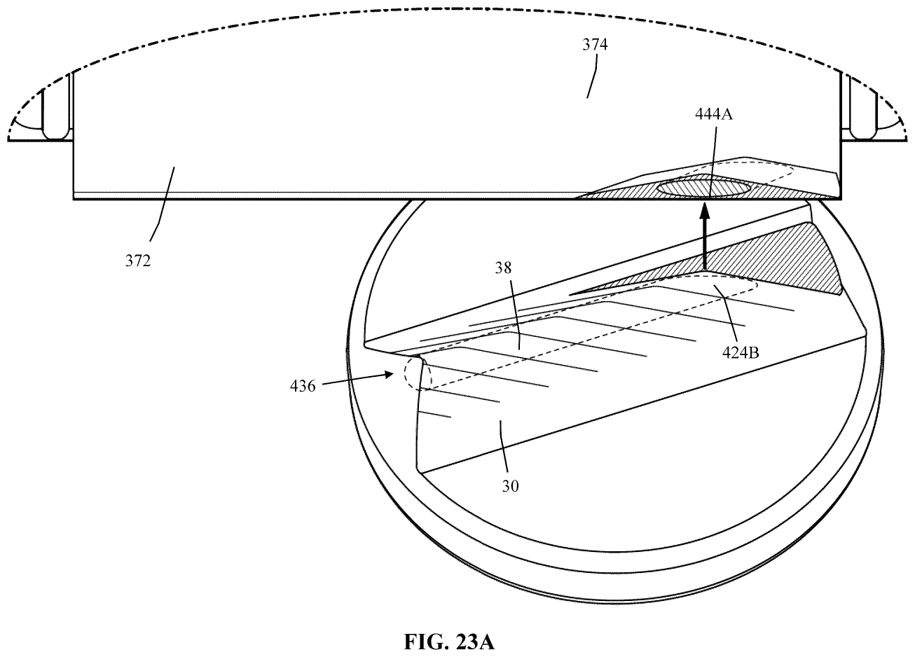

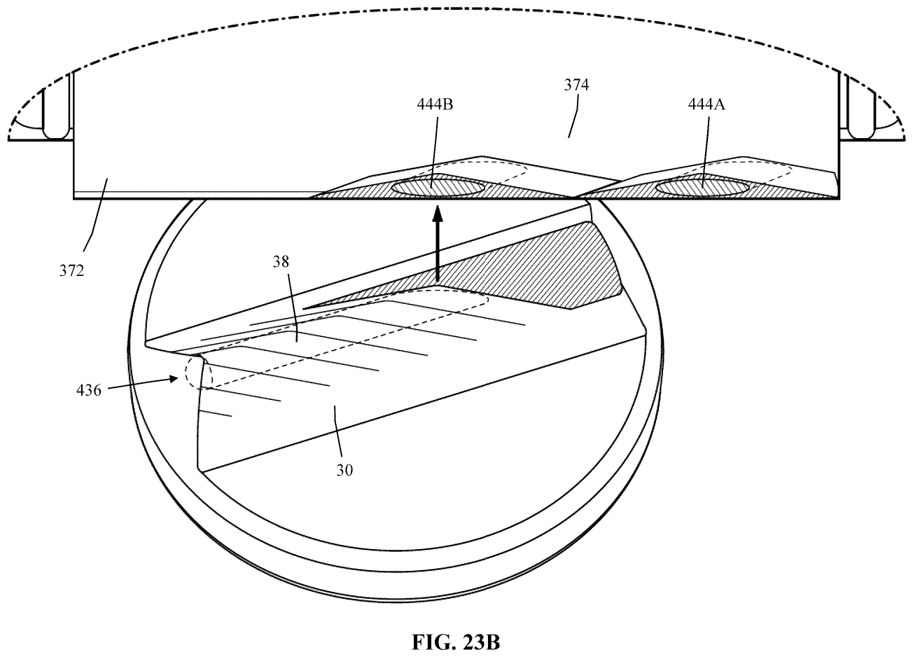

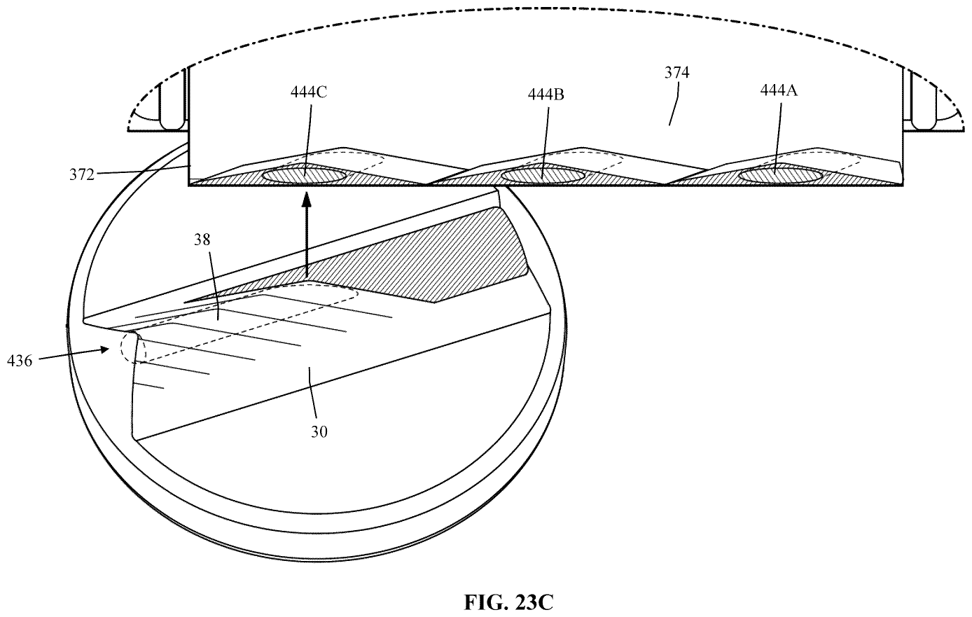

Fan Slice Collection. With reference to FIGS. 22A-22D and 23A-23C a method of collecting a plurality of oblique slices is shown, as is referred to herein as “fan slice collection.” With reference to FIG. 22A, the fan slice collection begins after the plurality of parallel scoring cuts 420 have been made to the sample 38 and the embedding agent 30. The plurality of oblique slices 424 are removed with a plurality of passes of the second blade 372, with each one of the plurality of oblique slices 424 being removed with one of the plurality of passes. In other words, a single oblique slice 424 is removed at a time with a pass of the second blade 372. In some embodiments (e.g., the fan slice collection), the removing step (STEP 412) of the method 410 includes cutting the embedding agent 30 with the second blade 372 by traveling past the oblique slice 424A to be removed (FIG. 22B). The second blade 372 then reverses direction (FIG. 22C) such that the second blade 372 is positioned under only the oblique slice 424A to be removed. The second blade 372 is then moved upwards relative to the sample assembly 46 to create the separated oblique slice 444A supported on the top planar surface 374 of the second blade 372 (FIG. 23A). In the illustrated embodiment, upwards relative movement for the second blade 372 is generated by lowering the sample assembly 46 with the Z-axis translation assembly 318. The process is then repeated to remove the next oblique slice 424B, but the second blade 372 is laterally offset relative to the sample assembly 46 (e.g., along the X axis 316) between each of the plurality of separation passes. With reference to FIG. 23B, this results in the second separated oblique slice 444B being collected on the second blade 372 at a position adjacent to the first separated oblique slice 444A on the second blade 372. With reference to FIG. 23C, the process repeats such that the plurality of separated oblique slices 444A, 444B, 444C are collected on the second blade 372 with adjacent oblique slices from the sample positioned adjacent on the second blade 372. Any number of oblique slices may be separated and collected on the second blade in this fan slice collection manner. Advantageously, the fan slice collection allows the operator to easily gather a plurality of adjacent slices arranged in order on the second blade.

In some embodiments, the cutting assembly 310 further includes a processor and a memory containing instructions executable by the processor to perform one or more of the steps or functions detailed herein.

The cutting assembly 310 and method 410 detailed herein have several advantages. The invention facilitates the cutting of embedded samples to rapidly generate consistent oblique slices of the sample. In some embodiments, the method 410 takes less than approximately 5 minutes to complete. In some embodiments, the method 410 takes less than approximately 3 minutes to complete. The method is highly repeatable that minimizes handling time of tissue and reduces variance in cutting between tissue samples. The cutting assembly 310 facilitates the cutting of the encased biopsy samples to render consistent sections of biopsied tissue. The optimal sectioning of live tumor biopsy allows for the largest number of consistent oblique sections of embedded biopsy tissue, while mitigating destruction of biopsy tissue during the cutting process to maintain cell viability.

### Blade Assembly

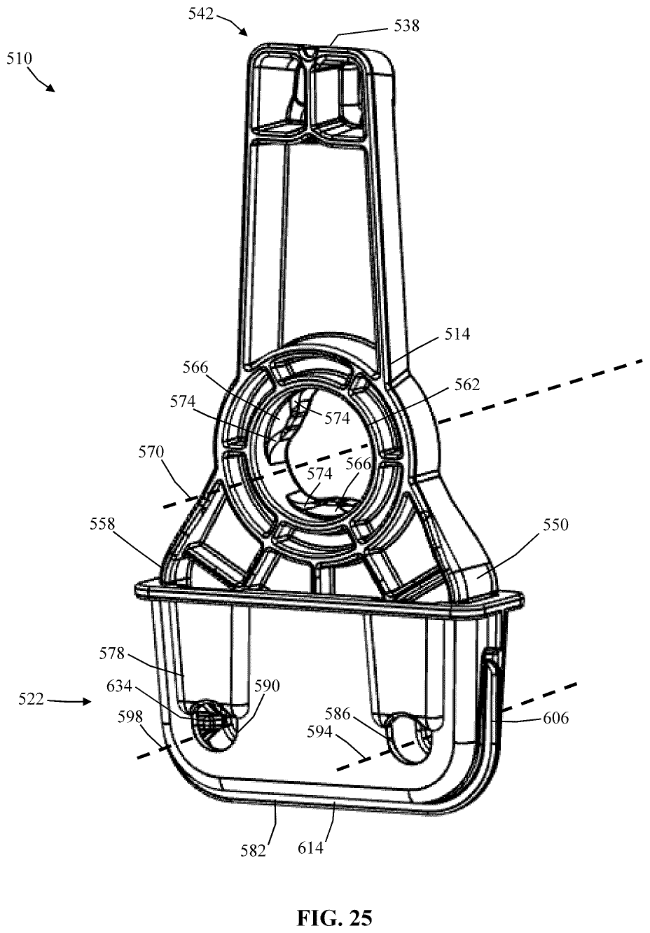

With reference to FIG. 25-27, a blade assembly 510 including a body 514, a blade 518, and a cover 522. The body 514 includes a blade mount surface 526 and the blade 518 is coupled to the blade mount surface 526. In the illustrated embodiment, the blade 518 is affixed to and abuts the blade mount surface 526. The blade 518 defines a cutting plane 530. The blade mount surface 526 is at a first end 534 of the body 514. The body 514 further includes a detent channel 538 formed at a second end 542 of the body 514, opposite the first end 534. The body 514 includes a first locking ledge 546 formed on a first side 550 of the body 514 and a second locking ledge 554 formed on a second side 558 of the body 514, opposite the first side 550.

The body 514 includes a mounting aperture 562 with a plurality of protrusions 566 extending radially inward from the mounting aperture 562. The mounting aperture 562 defines an axis 570. In the illustrated embodiment, the axis 570 is spaced from the blade 518. In other words, the axis 570 does not intersect the blade 518. In the illustrated embodiment, the mounting aperture 562 is positioned between the blade mount surface 526 and the detent channel 538.

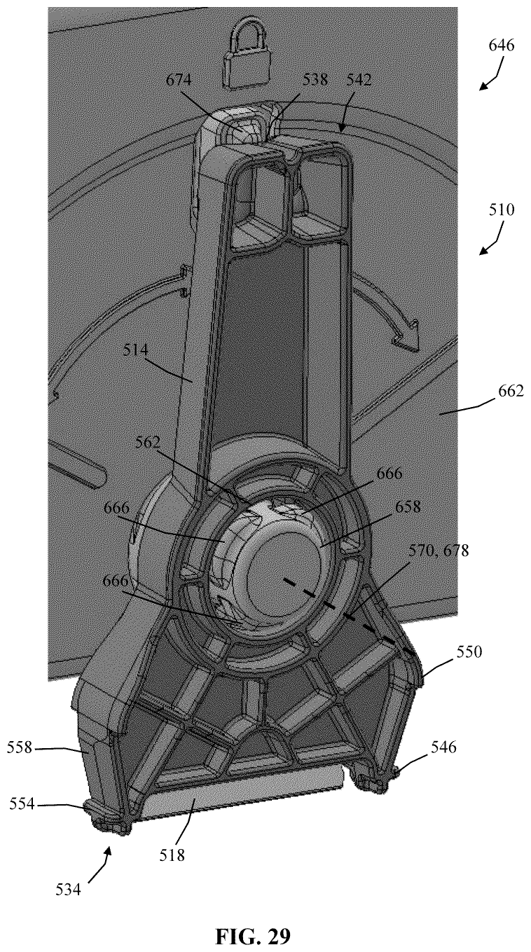

In the illustrated embodiment, each of the plurality of protrusions 566 includes a ramped surface 574. As detailed further herein, the ramped surface 574 interfaces with the plurality of protrusions 666 on the boss 658 of the blade assembly mount 646 (FIG. 29) to provide a kinetic attachment that is easy to use and reproducible by users.

As detailed further herein, the cover 522 is removably coupled to the body 514. In the illustrated embodiment, the cover 522 includes a cover body 578, a latch 582, a first aperture 586, and a second aperture 590. The first aperture 586 and the second aperture 590 are formed in the cover body 578. In some embodiments, the cover body 578 includes one or more apertures. The first aperture 586 defines a first axis 594 and the second aperture 590 defines a second axis 598. In the illustrated embodiment, the first axis 594 is spaced from the blade 518 and the second axis 598 is spaced from the blade 518. In the illustrated embodiment, the second axis 598 is spaced from and parallel to the first axis 594. In the illustrated embodiment, the second axis 598 and the first axis 594 are spaced from and parallel to the axis 570 of the mounting aperture 562 formed in the body 514.

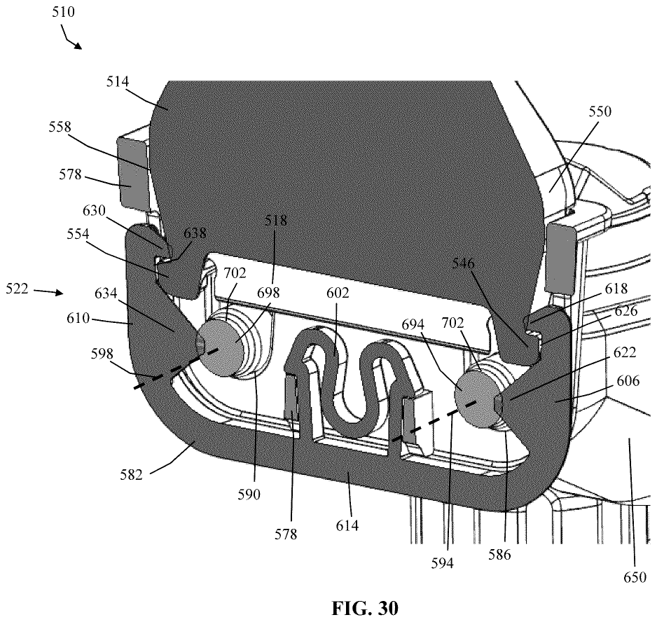

With continued reference to FIG. 30, the latch 582 includes an anchor 602 secured to the cover body 578. The latch 582 includes a first arm 606, a second arm 610, and an intermediate portion 614 extending between the first arm 606 and the second arm 610. In the illustrated embodiment, the anchor 602 extends from the intermediate portion 614. The first arm 606 includes a first portion 618 and a second portion 622 formed on a first inner surface 626 of the first arm 606. The second arm 610 includes a third portion 630 and a fourth portion 634 formed on a second inner surface 638 of the second arm 610. In the illustrated embodiment, the second arm 610 is the mirrored structure of the first arm 606. As detailed further herein, the first portion 618 of the first arm 606 is configured to abut the first locking ledge 546 of the body 514, and the third portion 630 of the second arm 610 is configured to abut the second locking ledge 554 of the body 514. The second portion 622 of the first arm 606 is configured to extend into the first aperture 586, and the fourth portion 634 of the second arm 610 is configured to extend into the second aperture 590. As detailed further herein, the second portion 622 and the fourth portion 634 of the latch 582 interface with the first peg 694 and the second peg 698 (e.g., the cover key 654).

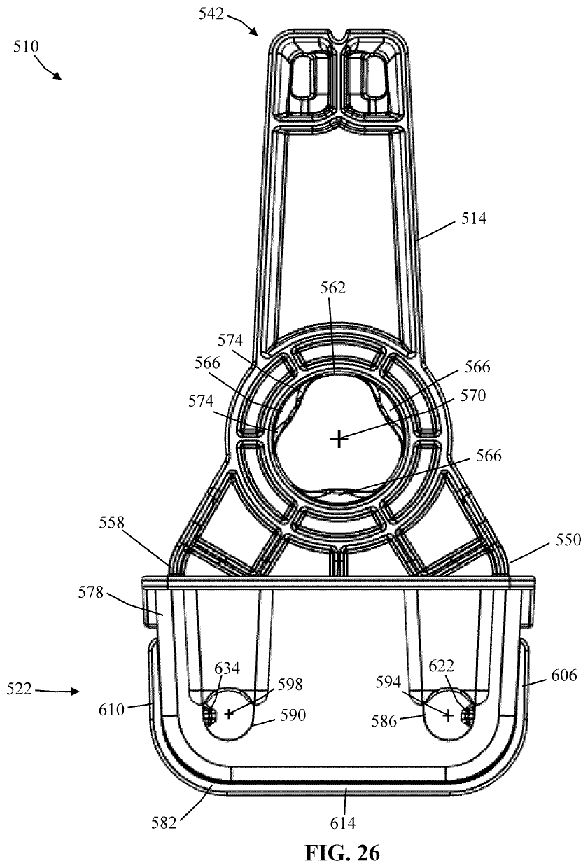

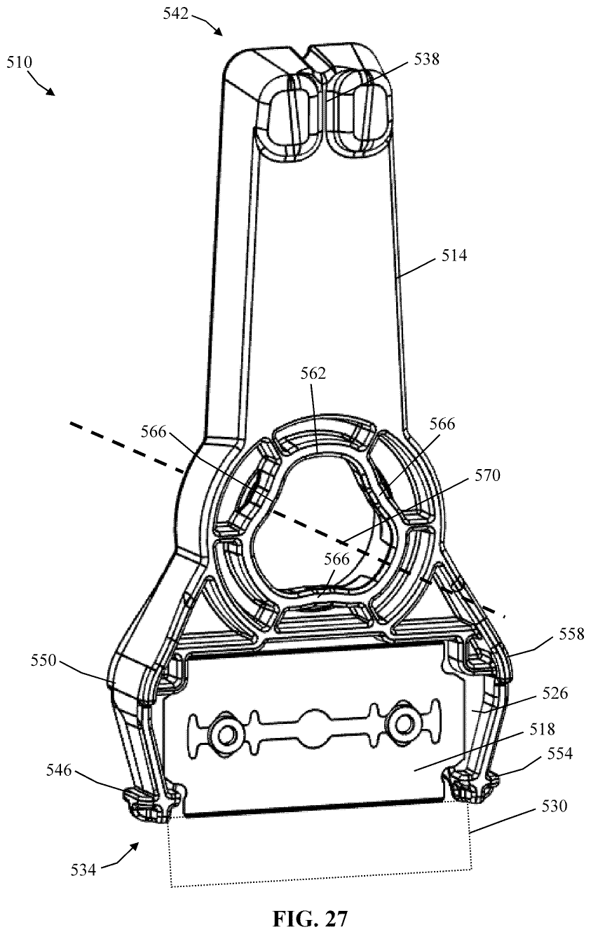

As detailed herein, the blade assembly 510 is movable between a first configuration (e.g., a covered configuration, FIGS. 25 and 26) and a second configuration (e.g., an uncovered configuration, FIG. 27). In the first configuration, the cover 522 is coupled to the body 514 and positioned over the blade 518. In other words, in the first configuration, the cover 522 blocks the blade 518 to prevent accidental contact with the blade 518 by a user. In the first configuration, the cutting plane 530 of the blade 518 intersects the cover 522. Also in the first configuration, the latch 582 abuts the body 514 (FIG. 30). In the illustrated embodiment, the latch 582 abuts the first locking ledge 546 and the second locking ledge 554 in the first configuration. In the first configuration, the first portion 618 of the first arm 606 abuts the first locking ledge 546 of the body 514 and the third portion 630 of the second arm 610 abuts the second locking ledge 554 of the body 514. As such, the cover 522 is advantageously secured to the body 514 and blocking the blade 518 in the first configuration.

Also in the first configuration, the second portion 622 of the first arm 606 extends into the first aperture 586, and the fourth portion 634 of the second arm 610 extends into the second aperture 590 (FIG. 26). In the second configuration of the blade assembly 510 (FIG. 27), the cover 522 is removed from the body 514 and the blade 518 is exposed. In other words, the blade 518 is ready for cutting use in the second configuration. With reference to FIG. 30, in the illustrated embodiment, the latch 582 is movable with respect to the body 514 in response to insertion of a key into the first aperture 586 and the second aperture 590.

In some embodiments, the blade assembly 510 is single-use, which advantageously prevents cross-contamination while also providing the sharpest possible blade to improve tissue viability.

### Cutting Assembly

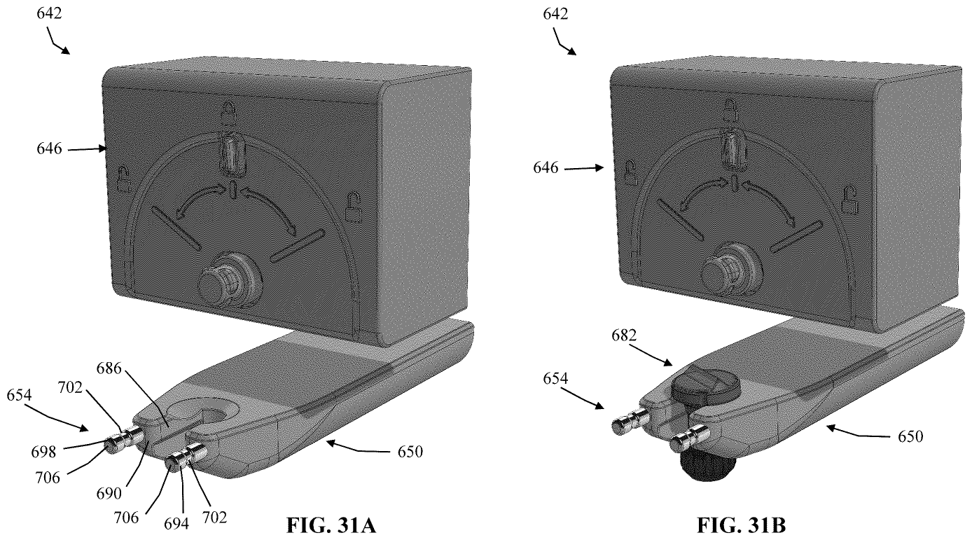

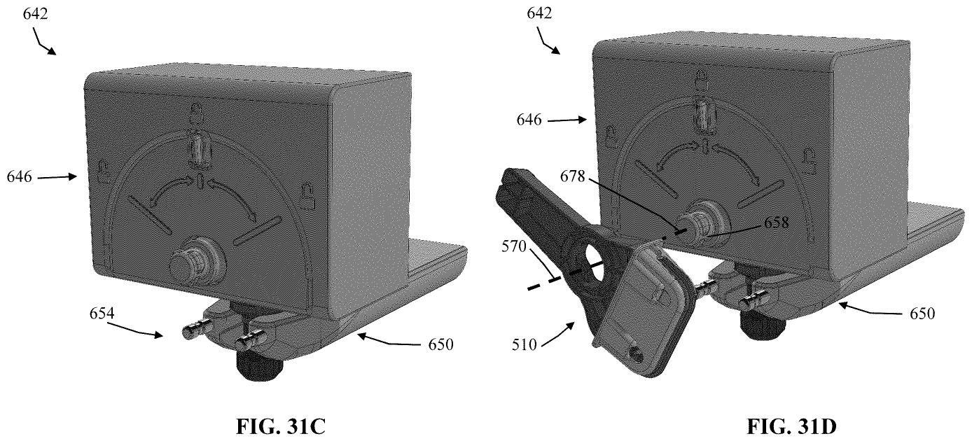

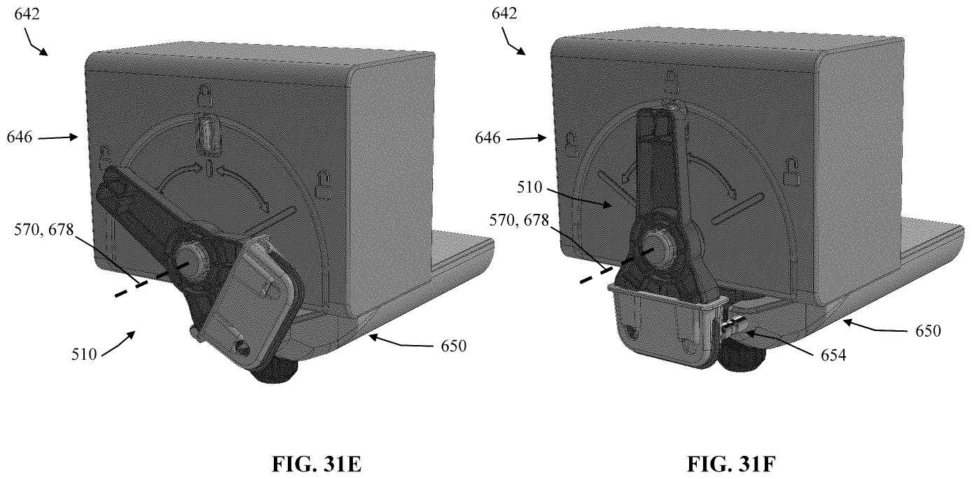

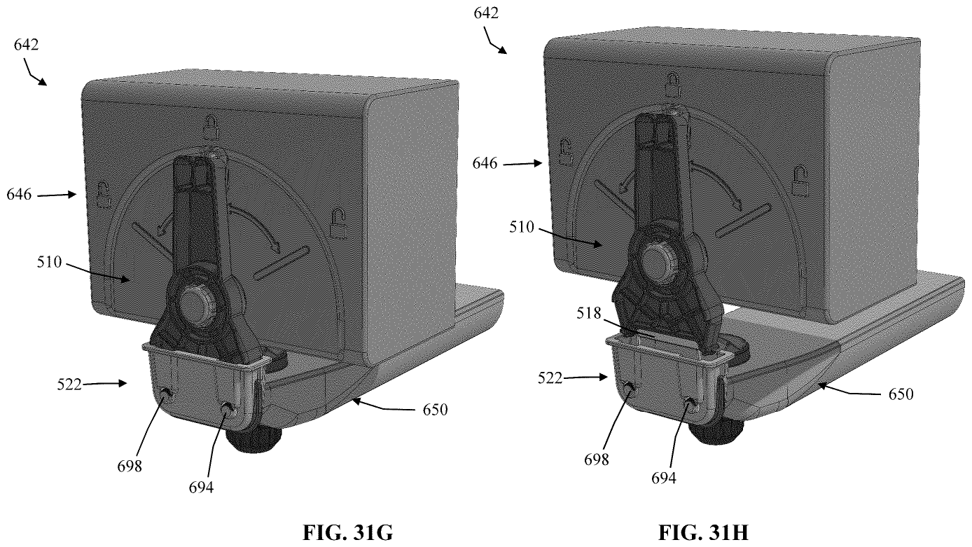

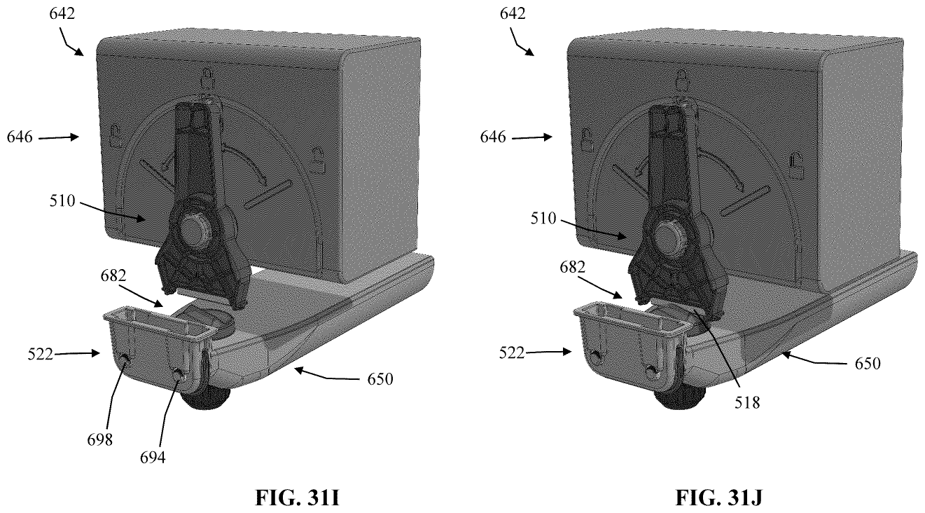

With reference to FIG. 31A, a cutting assembly 642 includes the blade assembly 510, a blade assembly mount 646, a sample mount 650, and a cover key 654. As detailed herein, the blade assembly 510 includes the blade 518 and the cover 522, and the blade assembly 510 is removably coupled to the blade assembly mount 646 without the use of tools. In other words, a tool-free and removable connection is provided between the blade assembly 510 and the blade assembly mount 646.

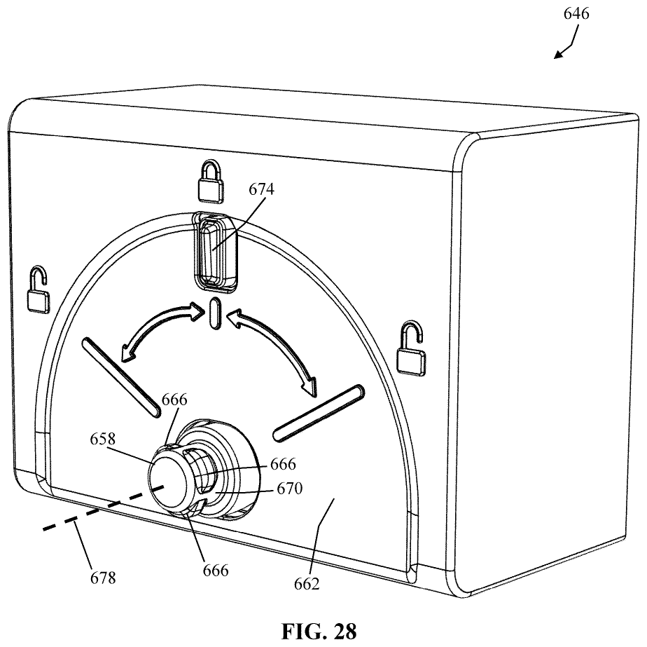

With reference to FIGS. 28 and 29, the blade assembly mount 646 includes a boss 658 extending from a surface 662. The boss 658 includes a plurality of protrusions 666 that radially extend from a cylindrical surface 670. The plurality of protrusions 666 corresponds to the plurality of protrusions 566 that radially extend inward from the mounting aperture 562 of the blade assembly 510. In the illustrated embodiment, the blade assembly mount 646 further includes a detent 674. With reference to FIG. 29, the blade assembly 510 includes the detent channel 538 that is configured to receive the detent 674 when the blade assembly 510 is attached to the blade assembly mount 646.

In the illustrated embodiment, the blade assembly 510 is coupled to the blade assembly mount 646 in response to a first movement of the blade assembly 510 along an axis 678, and a second movement, after the first movement, of the blade assembly 510 about the axis 678. In other words, the blade assembly 510 is attached to the blade assembly mount 646 by inserting the blade assembly 510 along the axis 678 and then rotating the blade assembly 510 about the axis 678. In the illustrated embodiment, the axis 678 is aligned with the boss 658 of the blade assembly mount 646. In some embodiments, the axis 678 is oriented horizontally. As the blade assembly 510 moves along the axis 678, during the first movement of installation, the axis 570 of the mounting aperture 562 is aligned with and coaxial with the axis 678.

With reference to FIGS. 31A and 31B, the sample mount 650 is configured to receive a sample assembly 682 to be processed by the blade 518. In the illustrated embodiment, the sample mount 650 includes a slot 686 formed in a front surface 690. The slot 686 is configured to receive the sample assembly 682 to be processed by the blade 518. The sample assembly to be processed may be any of the suitable sample assemblies disclosed herein.

With reference to FIGS. 30 and 31F-31H, the cover key 654 interfaces with the cover 522 to release and remove the cover 522 from remaining portions of the blade assembly 510. In some embodiments, the cover key 564 is positioned on the sample mount. In the illustrated embodiment, the cover key 564 is a first peg 694 and a second peg 698 that extends from the front surface 690 of the sample mount 650. In some embodiments, the cover key 654 is a single peg. In other embodiments, the cover key 654 is any suitable structure to interface with the cover 522 for releasing the cover 522 for removal from the remaining portions of the blade assembly 510. In the illustrated embodiment, the first peg 694 and the second peg 698 each include a reduced diameter portion 702 spaced from a distal end 706. The latch 582 of the cover 522 abuts the reduced diameter portion 702 when the first peg 694 is inserted in the first aperture 586 and the second peg 698 is inserted in the second aperture 590. Advantageously, the cover 522 is securely retrained on the first peg 694 and the second peg 698 after the remaining portions of blade assembly 510 are separated from the cover 522. As such, the cover 522 is in position and accessible for reattaching the cover 522 to the remaining portions of the blade assembly 510 after the sample processing steps with blade 518 are complete.

FIGS. 31A-31J illustrate a process including method steps performed by a user and method steps performed by the cutting assembly 642.

FIG. 31A is a perspective view of the cutting assembly 642 including the blade assembly mount 646 and the sample mount 650.

FIG. 31B is a perspective view illustrating a step of coupling the sample assembly 682 to the sample mount 650.

FIG. 31C is a perspective view illustrating a step of moving the blade assembly mount 646 relative to the sample mount 650.

FIG. 31D is a perspective view of a step of attaching the blade assembly 510 to the blade assembly mount 646.

FIG. 31E is a perspective view of the step of attaching the blade assembly 510 to the blade assembly mount 646 by moving the blade assembly 510 along the axis 678. In the illustrated embodiment, the axis 570 of the mounting aperture 562 is aligned with the axis 678 during the installation step.

FIG. 31F is a perspective view of the step of attaching the blade assembly 510 to the blade assembly mount 646 by moving the blade assembly 510 about the axis 678.

FIG. 31G is a perspective view of a step of removing a cover 522 from the blade assembly 510 by inserting a cover key 654 into the cover 522. In the illustrated embodiment, the first peg 694 is inserted into the first aperture 586 of the cover 522, and the second peg 698 is inserted into the second aperture 590 of the cover 522.

FIG. 31H is a perspective view of the step of removing the cover 522 from the remaining portions of the blade assembly 510 by moving the blade 518 relative to the cover 522 while the cover key 654 is positioned within the cover 522.

FIG. 31I is a perspective view of a step of moving the blade assembly mount 646 relative to the sample mount 650 after the cover 522 has been removed from the blade assembly 510.

FIG. 31J is a perspective view of a step of performing a processing step of the sample assembly 682. After the processing step of the sample assembly 682 is completed, the cover 522 can be reattached to the blade assembly 510 by performing, for example, the steps illustrated in FIGS. 31F-31I in reverse order.

### User Method

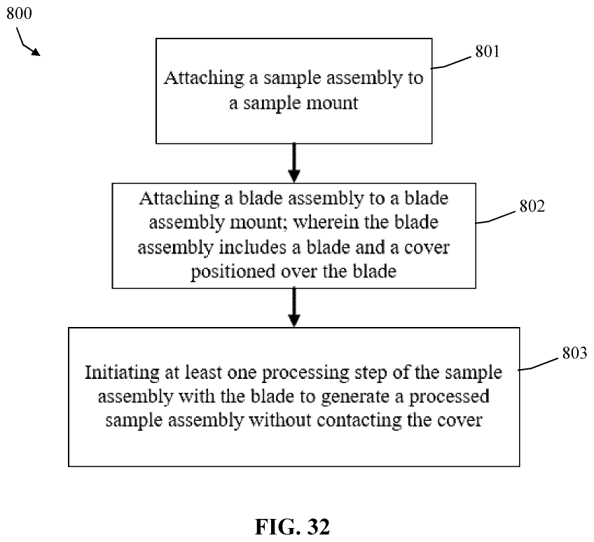

With reference to FIG. 32, a method 800 includes (STEP 801) attaching a sample assembly to a sample mount (e.g., FIGS. 31A-31B) and (STEP 802) attaching a blade assembly to a blade assembly mount (e.g., FIGS. 31C-31F). The blade assembly includes a blade and a cover positioned over the blade. In some embodiments, attaching the blade assembly to the blade assembly mount includes moving the blade assembly in a first direction along a first axis (e.g., along the axis 678 of FIGS. 31D-31E); and moving the blade assembly in a second direction about the first axis (e.g., about the axis 678 of FIGS. 31E-31F). As detailed herein, the blade assembly is attached to the blade assembly mount without the use of tools. Advantageously, the tool-less quick-change interface provides improved usability, reliability, and repeatability for positioning the blade assembly on the blade assembly mount.

The method 800 further includes (STEP 803) initiating at least one processing step of the sample assembly with the blade to generate a processed sample assembly without contacting the cover. In some embodiments, initiating at least one processing step includes closing a door on an enclosure or providing a user-input (e.g., a button press).

In some embodiments, the method 800 further comprises removing the blade assembly from the blade assembly mount. The cover is positioned over the blade when the blade assembly is removed. Advantageously, contacting the cover is not required. In some embodiments, the method 800 further comprises removing the processed sample assembly from the sample mount after the blade assembly is removed from the blade assembly mount. In some embodiments, installing the cutting assembly is the last step before initiating the processing step of the sample assembly, and removal of the cutting assembly is the first step after the processing step of the sample is completed.

In some embodiments, the method 800 is performed entirely by a user of the cutting assembly. Advantageously, the user performing the method 800 does not need to contact, remove, or reattach the cover, which is instead removed and reattached by the cutting system. This advantageously reduces the likelihood of accidental contact with the blade by the user. In other words, the method 800 provides improved operator safety.

### Cutting Assembly Method

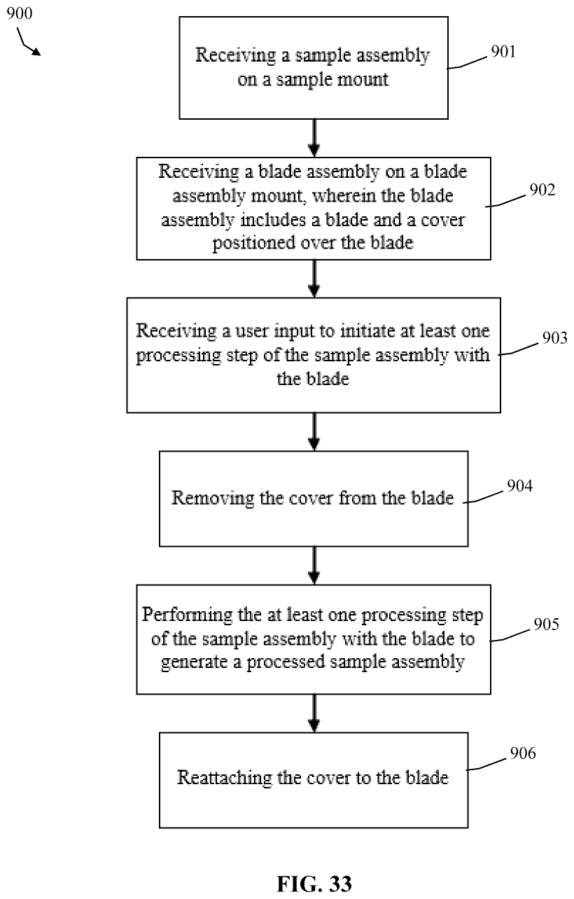

With reference to FIG. 33, a method 900 includes (STEP 901) receiving a sample assembly on a sample mount (e.g., FIGS. 31A-31B); and (STEP 902) receiving a blade assembly on a blade assembly mount (e.g., FIGS. 31D-31F). The blade assembly includes a blade and a cover positioned over the blade.

The method 900 further includes (STEP 903) receiving a user input to initiate at least one processing step of the sample assembly with the blade. In some embodiments, the user input is closing a door on an enclosure. In some embodiments, the user input is a press of a button.

The method 900 further includes (STEP 904) removing the cover from the blade (e.g., FIGS. 31G-31I). In some embodiments, removing the cover from the blade includes inserting a cover key into an aperture in the cover. In some embodiments, the cover key is positioned on the sample mount. In some embodiments, inserting the cover key into the aperture is along a first axis. In some embodiments, removing the cover from the blade further includes moving the blade with respect to the cover along a second axis while the cover key is in the aperture. In some embodiments, the second axis is orthogonal to the first axis. In the illustrated embodiment, the first axis is a horizontal axis and the second axis is a vertical axis.

The method 900 further includes (STEP 905) performing the at least one processing step of the sample assembly with the blade to generate a processed sample assembly (e.g., FIG. 31J).

The method 900 further includes (STEP 906) reattaching the cover the blade (e.g., FIGS. 311, 31H, and 31G). In some embodiments, reattaching the cover to the blade includes moving the blade with respect to the cover along the second axis while the cover key is in the aperture. In some embodiments, reattaching the cover to the blade includes the same steps to remove the cover but in reverse order. The method 900 does not require any human user interaction with the cover or the blade. Advantageously, the method 900 is performed automatically by a cutting assembly (e.g., the cutting assembly 642) without a user needing to contact the cover or the blade.

1. A system comprising:
a mold including a cavity at least partially formed by a surface and a wall;
wherein a trough is formed in the surface, and the trough is configured to support a sample therein; and
wherein a plurality of openings is formed in the trough; and
a holder including a frame and a scaffold positioned within the frame;
wherein the frame is receivable within the cavity.

2. The system of claim 1, wherein the surface is planar and the wall is a circumferential wall.

3. The system of claim 1, wherein the trough includes a first surface, a second surface, and a transition surface positioned between the first surface and the second surface.

4. The system of claim 3, wherein a plane defined by the first surface and a plane defined by the second surface intersect at an angle; wherein the angle is within a range of 60 degrees to 120 degrees.

5. The system of claim 3, wherein the transition surface is arcuate.

6. The system of claim 3, wherein the plurality of openings is formed in the first surface and the second surface.

7. The system of claim 6, wherein each of the plurality of openings is a slot that extends between the first surface and the second surface.

8. The system of claim 1, wherein the frame is receivable within the cavity in only a first orientation and a second orientation.

9. The system of claim 8, wherein the mold further includes a protrusion that extends from the wall; and wherein the frame of the holder includes an outer surface with a first groove and a second groove formed in the outer surface; and wherein the protrusion is received within the first groove or the second groove.

10. The system of claim 1, wherein the holder further includes a stem and a transition portion positioned between the frame and the stem.

11. The system of claim 10, wherein a thread is formed on an outer circumferential surface of the stem; and wherein the stem is hollow; and wherein the system further comprises a locking nut coupled to the thread formed on the stem.

12. The system of claim 10, wherein the transition portion includes an orienting flange and a fiducial.

13. The system of claim 1, wherein the scaffold is a gyroid lattice.

14. The system of claim 1, wherein the scaffold is a lattice of cones.

15. The system of claim 1, wherein the mold further includes a base having an outer circumferential surface, and a vent formed in the outer circumferential surface.

16. The system of claim 15, wherein the mold further includes a grip member positioned on the outer circumferential surface.

17. The system of claim 15, wherein the mold further includes a rib extending from the trough and an inner circumferential surface of the base.

18. The system of claim 1, wherein the mold further includes a ridge; and wherein the frame of the holder abuts the ridge when the frame is received within the cavity.

19. The system of claim 1, further comprising a waste tube; and wherein a base of the mold is receivable within the waste tube.

20. The system of claim 1, further comprising a sample tube including a sample in a liquid; and wherein the liquid drains through the plurality of openings as the sample is positioned within the trough of the mold.

21. The system of claim 1, further comprising an embedding agent positioned within the cavity.

22.-92. (canceled)
